(19) United States
(12) Patent Application Publication
(10) Pub. No.: US 2026/0029626 A1
(43) Pub. Date: Jan. 29, 2026

(54) OCULAR OPTICAL SYSTEM

(71) Applicant: GENIUS ELECTRONIC OPTICAL CO., LTD., Taichung City (TW)

(72) Inventors: Chun-Yang Huang, Taichung City (TW); Sheng-Wei Hsu, Taichung City (TW)

(73) Assignee: GENIUS ELECTRONIC OPTICAL CO., LTD., Taichung City (TW)

(21) Appl. No.: 18/970,800

(22) Filed: Dec. 5, 2024

(30) Foreign Application Priority Data
Jul. 23, 2024 (CN) 202410996348.4

(51) Int. Cl. G02B 13/18; G02B 9/12

(52) U.S. Cl. CPC G02B 13/18; G02B 9/12

(57) ABSTRACT

Disclosed is an ocular optical system configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system also includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. The ocular optical system satisfies the following conditional expression: 1.9≤|OXR11/Sag11|≤8.5.

### CROSS-REFERENCE TO RELATED APPLICATION

This application claims the priority benefit of China application serial no. 202410996348.4, filed on Jul. 23, 2024. The entirety of the above-mentioned patent application is hereby incorporated by reference herein and made a part of this specification.

### BACKGROUND

### Technical Field

The present disclosure relates to an optical system, and in particular to an ocular optical system.

### Description of Related Art

The existing ocular optical systems used in VR on the market may be mainly divided into three categories: aspheric optical elements, Fresnel optical elements and Pancake optical elements. The advantage of aspheric optical elements is that the manufacturing cost is low and they are less likely to be affected by stray light problems such as flare and ghost. However, aspheric optical elements are heavy in weight and large in size. The advantage of Fresnel optical elements is light weight and they have improved half field of view, but the manufacturing cost is higher than that of aspheric optical elements, and the disadvantage of Fresnel optical elements lies in a serious flare problem. The advantage of pancake optical elements is that the weight and size thereof may be less than half of aspheric optical elements, and there is no glare problem. However, since the material cost of the optical film is half of the cost of the lens, plus a coating process is involved and there is high difficulty in achieving good assembly accuracy and correction, the manufacturing cost is about 10 to 40 times that of aspheric optical elements, and ghost problem occurs as well.

In light of the foregoing, the advantage of lightweight of pancake optical elements makes it the mainstream in current development of the related field, but the production yield is low and the cost is high. Therefore, how to solve the above problems is one of the issues to be overcome by practitioners in the field of research and development for the industry. In addition, how to increase the half field of view, make the ocular optical system to have lightweight and improve imaging quality are also problems to be solved.

### SUMMARY

The present disclosure provides an ocular optical system that, in addition to meeting consumer demands for image quality and magnification, may also reduce the weight and size of the ocular optical system, while further lowering the production cost of the ocular optical system.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. In an embodiment of the present disclosure, the optical axis region of the eye-side surface of the first lens element, the optical axis region of the eye-side surface of the second lens element, and the optical axis region of the eye-side surface of the third lens element are all concave. The curvature direction of the optical axis region of the display-side surface of the second lens element is consistent with the curvature direction of the optical axis region of the display-side surface of the first lens element and the curvature direction of the optical axis region of the display-side surface of the third lens element. The ocular optical system satisfies a conditional expression as follows: 1.9≤|OXR11/Sag11|≤8.5; or 2.9≤|OXR12/Sag12|≤9.0; or |Sag12|≤7.0 mm, wherein OXR11 is an optical maximum radius of the eye-side surface of the first lens element, OXR12 is an optical maximum radius of the display-side surface of the first lens element, Sag11 is a Sag value of the eye-side surface of the first lens element at the optical maximum radius, Sag12 is a Sag value of the display-side surface of the first lens element at the optical maximum radius, wherein Sag is a depth of an aspheric surface derived from the aspheric surface formula.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: T2>T3; or T1>T3, wherein T1 is a thickness of the first lens element along the optical axis, T2 is a thickness of the second lens element along the optical axis, and T3 is a thickness of the third lens element along the optical axis.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: OXR11 is consistent with OXR32; or OXR12 is consistent with OXR32; or OXR21 is consistent with OXR32; or OXR22 is consistent with OXR32; or OXR31 is consistent with OXR32, wherein OXR21 is the optical maximum radius of the eye-side surface of the second lens element, OXR22 is the optical maximum radius of the display-side surface of the second lens element, OXR31 is the optical maximum radius of the eye-side surface of the third lens element, and OXR32 is the optical maximum radius of the display-side surface of the third lens element.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: 10≤V1/n1≤45; or 32≤V2/n2≤45; or 32≤V3/n3≤45, wherein V1 is a Vd Abbe number of the first lens element, V2 is a Vd Abbe number of the second lens element, V3 is a Vd Abbe number of the third lens element, n1 is a nd refractive index of the first lens element, n2 is a nd refractive index of the second lens element, and n3 is the nd refractive index of the third lens element.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: 9.5≤(ER+TL+BFL)/BFL≤28.0; or 1.55≤(ER+TL+BFL)/EFL≤1.9; or 3.5≤TL/BFL≤13.5, wherein ER is a distance on the optical axis from the eye of the observer to the first lens element, TL is a distance on the optical axis from the eye-side surface of the first lens element to the display-side surface of the third lens element, BFL is a distance on the optical axis from the display-side surface of the third lens element to the display screen, and EFL is an effective focal length of the ocular optical system.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: 1.00≤OXR11/ImgH≤1.70; or 1.55≤OXR12/ImgH≤1.80; or 1.55≤OXR21/ImgH≤1.80; or 1.55≤OXR22/ImgH≤1.80; or 1.55≤OXR31/ImgH≤1.80; or 1.55≤OXR32/ImgH≤1.80, wherein ImgH is a maximum image height of the ocular optical system.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: 40≤|ObjD|/SL≤49; or 77≤|ObjD|/TTL≤110; or 82≤|ObjD|/TL≤125, wherein ObjD is a distance on the optical axis from the eye of observer to the virtual image generated by the ocular optical system, SL is a system length of the ocular optical system, that is, a distance on the optical axis from the eye of the observer to the display screen, and TTL is a distance on the optical axis from the eye-side surface of the first lens element to the display screen.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows:

$$3.0 ≦ OXR 11 / T 1 ≦ 21. ; or$$

$$5. ≦ OXR 12 / T 1 ≦ 21. ; or \\ 2.5 ≦ OXR 21 / T 2 ≦ 4.3 ; or \\ 2.5 ≦ OXR 22 / T 2 ≦ 4.3 ; or \\ 4.7 ≦ OXR 31 / T 3 ≦ 10.5 ; or \\ 4.7 ≦ OXR 32 / T 3 ≦ 10.5 .$$

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows: 1.3≤T1/AAG≤5.2; or 4.6≤T2/AAG≤11.0; or 2.6≤T3/AAG≤6.6, wherein AAG is the sum of the distance on the optical axis from the display-side surface of the first lens element to the eye-side surface of the second lens element and the distance on the optical axis from the display-side surface of the second lens element to the eye-side surface of the third lens element.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows:

$$3.6 ≦ ER / T 1 ≦ 15. ; or \\ 2.05 ≦ ER / T 2 ≦ 3. ; or \\ 3.3 ≦ ER / T 3 ≦ 7.5 .$$

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows:

$$2.0 ≦ ( OXR 11 + OXR 12 ) / ( ImgH + BFL ) ≦ 3.1 ; or \\ 2.6 ≦ ( OXR 21 + OXR 22 ) / ( ImgH + BFL ) ≦ 3.5 ; or \\ 2.6 ≦ ( OXR 31 + OXR 32 ) / ( ImgH + BFL ) ≦ 3.5 .$$

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows:

$$2.7 ≦ ImgH / T 1 ≦ 13. ; or \\ 1.6 ≦ ImgH / T 2 ≦ 2.5 ; or \\ 2.7 ≦ ImgH / T 3 ≦ 6.5 .$$

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows:

$$4.4 ≦ ImgH / BFL ≦ 11.5 ; or \\ 0.5 ≦ T 1 / BFL ≦ 3.7 ; or \\ 2.2 ≦ T 2 / BFL ≦ 6.2 ; or \\ 0.7 ≦ T 3 / BFL ≦ 3.9 .$$

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the second lens element has positive refracting power, and the third lens element has negative refracting power.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the second lens element has negative refracting power, and the third lens element has positive refracting power.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the first lens element has negative refracting power, and the second lens element has positive refracting power.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. In the radial direction of the second lens element, there is an inflection point from the optical axis to the optical maximum radius of the display-side surface of the second lens element.

In an embodiment of the disclosure, an ocular optical system is configured to allow an imaging ray from a display screen to enter an eye of an observer through the ocular optical system to form an image. The ocular optical system includes a first lens element, a second lens element, a third lens element, and a partial mirror sequentially arranged along an optical axis from an eye-side to a display-side. The ocular optical system further includes a linear polarizing film, a reflective polarizing film and a quarter-wave plate disposed on a convex surface of an optical axis region of the display-side surface of the first lens element. The partial mirror is disposed on a convex surface of an optical axis region of the display-side surface of the third lens element. Moreover, the ocular optical system satisfies a conditional expression as follows:

$$2.4 ≦ ALT / EPD ≦ 3.8 ; or \\ 2.5 ≦ TL / EPD ≦ 3.9 ; or \\ 2.9 ≦ ImgH / EPD ≦ 3.4 .$$

Based on the above, the advantageous effects of the ocular optical system according to the embodiments of the present disclosure are: by satisfying the conditions of optical design, and disposing the linear polarizing film, the reflective polarizing film and the quarter-wave plate on the convex surface of the display-side surface of the first lens element, it is possible to help reduce the coating process to reduce manufacturing costs, and make the ocular optical system lighter. In addition, disposing a partial mirror on the convex surface of the display-side surface of the third lens element also helps to increase the half field of view through the principles of reflection and polarization, thus satisfying consumers' demand for a wide field of view of images.

In order to make the above-mentioned features and advantages of the present disclosure more obvious and easy to understand, embodiments are given below and are described in detail below with reference to the attached drawings.

### BRIEF DESCRIPTION OF THE DRAWINGS

FIG. 1 is a schematic diagram illustrating an imaging ray emitted by a display screen entering an eye through the ocular optical system.

FIG. 2 is a schematic diagram illustrating a surface shape structure of a lens element.

FIG. 3 is a schematic diagram illustrating a concave-convex structure and a point of intersection of rays of a lens element.

FIG. 4 is a schematic diagram illustrating a surface shape structure of a lens element of Example 1.

FIG. 5 is a schematic diagram illustrating a surface shape structure of a lens element of Example 2.

FIG. 6 is a schematic diagram illustrating a surface shape structure of a lens element of Example 3.

FIG. 7 is a schematic diagram of an ocular optical system according to the first embodiment of the present disclosure.

FIG. 8A to FIG. 8D are diagrams of longitudinal spherical aberrations and various optical aberrations of the ocular optical system of the first embodiment of the disclosure.

FIG. 9 shows detailed optical data of the ocular optical system of the first embodiment of the disclosure.

FIG. 10 shows aspheric parameters of the ocular optical system of the first embodiment of the disclosure.

FIG. 11 is a schematic diagram of an ocular optical system according to the second embodiment of the present disclosure.

FIG. 12A to FIG. 12D are diagrams of longitudinal spherical aberrations and various optical aberrations of the ocular optical system of the second embodiment of the disclosure.

FIG. 13 shows detailed optical data of the ocular optical system of the second embodiment of the disclosure.

FIG. 14 shows aspheric parameters of the ocular optical system of the second embodiment of the disclosure.

FIG. 15 is a schematic diagram of an ocular optical system according to the third embodiment of the present disclosure.

FIG. 16A to FIG. 16D are diagrams of longitudinal spherical aberrations and various optical aberrations of the ocular optical system of the third embodiment of the disclosure.

FIG. 17 shows detailed optical data of the ocular optical system of the third embodiment of the disclosure.

FIG. 18 shows aspheric parameters of the ocular optical system of the third embodiment of the disclosure.

FIG. 19 is a schematic diagram of an ocular optical system according to the fourth embodiment of the present disclosure.

FIG. 20A to FIG. 20D are diagrams of longitudinal spherical aberrations and various optical aberrations of the ocular optical system of the fourth embodiment of the disclosure.

FIG. 21 shows detailed optical data of the ocular optical system of the fourth embodiment of the disclosure.

FIG. 22 shows aspheric parameters of the ocular optical system of the fourth embodiment of the disclosure.

FIG. 23 is a schematic diagram of an ocular optical system according to the fifth embodiment of the present disclosure.

FIG. 24A to FIG. 24D are diagrams of longitudinal spherical aberrations and various optical aberrations of the ocular optical system of the fifth embodiment of the disclosure.

FIG. 25 shows detailed optical data of the ocular optical system of the fifth embodiment of the disclosure.

FIG. 26 shows aspheric parameters of the ocular optical system of the fifth embodiment of the disclosure.

FIG. 27 is a schematic diagram of an ocular optical system of the sixth embodiment of the disclosure.

FIG. 28A to FIG. 28D are diagrams of longitudinal spherical aberrations and various optical aberrations of the ocular optical system of the sixth embodiment of the disclosure.

FIG. 29 shows detailed optical data of the ocular optical system of the sixth embodiment of the disclosure.

FIG. 30 shows aspheric parameters of the ocular optical system of the sixth embodiment of the disclosure.

FIG. 31 is a schematic diagram of an ocular optical system of the seventh embodiment of the disclosure.

FIG. 32A to FIG. 32D are diagrams of longitudinal spherical aberrations and various optical aberrations of the ocular optical system of the seventh embodiment of the disclosure.

FIG. 33 shows detailed optical data of the ocular optical system of the seventh embodiment of the disclosure.

FIG. 34 shows aspheric parameters of the ocular optical system of the seventh embodiment of the disclosure.

FIG. 35 is a schematic diagram of an ocular optical system of the eighth embodiment of the disclosure.

FIG. 36A to FIG. 36D are diagrams of longitudinal spherical aberrations and various optical aberrations of the ocular optical system of the eighth embodiment of the disclosure.

FIG. 37 shows detailed optical data of the ocular optical system of the eighth embodiment of the disclosure.

FIG. 38 shows aspheric parameters of the ocular optical system of the eighth embodiment of the disclosure.

FIG. 39 is a schematic diagram of an ocular optical system of the ninth embodiment of the disclosure.

FIG. 40A to FIG. 40D are diagrams of longitudinal spherical aberrations and various optical aberrations of the ocular optical system of the ninth embodiment of the disclosure.

FIG. 41 shows detailed optical data of the ocular optical system of the ninth embodiment of the disclosure.

FIG. 42 shows aspheric parameters of the ocular optical system of the ninth embodiment of the disclosure.

FIG. 43 is a schematic diagram of an ocular optical system of the tenth embodiment of the disclosure.

FIG. 44A to FIG. 44D are diagrams of longitudinal spherical aberrations and various optical aberrations of the ocular optical system of the tenth embodiment of the disclosure.

FIG. 45 shows detailed optical data of the ocular optical system of the tenth embodiment of the disclosure.

FIG. 46 shows aspheric parameters of the ocular optical system of the tenth embodiment of the disclosure.

FIG. 47 is a schematic diagram of an ocular optical system of the eleventh embodiment of the disclosure.

FIG. 48A to FIG. 48D are diagrams of longitudinal spherical aberrations and various optical aberrations of the ocular optical system of the eleventh embodiment of the disclosure.

FIG. 49 shows detailed optical data of the ocular optical system of the eleventh embodiment of the disclosure.

FIG. 50 shows aspheric parameters of the ocular optical system of the eleventh embodiment of the disclosure.

FIG. 51 is a schematic diagram of an ocular optical system of the twelfth embodiment of the disclosure.

FIG. 52A to FIG. 52D are diagrams of longitudinal spherical aberrations and various optical aberrations of the ocular optical system of the twelfth embodiment of the disclosure.

FIG. 53 shows detailed optical data of the ocular optical system of the twelfth embodiment of the disclosure.

FIG. 54 shows aspheric parameters of the ocular optical system of the twelfth embodiment of the disclosure.

FIG. 55 is a schematic diagram of an ocular optical system of the thirteenth embodiment of the disclosure.

FIG. 56A to FIG. 56D are diagrams of longitudinal spherical aberrations and various optical aberrations of the ocular optical system of the thirteenth embodiment of the disclosure.

FIG. 57 shows detailed optical data of the ocular optical system of the thirteenth embodiment of the disclosure.

FIG. 58 shows aspheric parameters of the ocular optical system of the thirteenth embodiment of the disclosure.

FIG. 59 to FIG. 61 show values of relational expressions of important parameters of the ocular optical systems of the first to seventh embodiments of the disclosure.

FIG. 62 to FIG. 64 show values of relational expressions of important parameters of the ocular optical systems of the eighth to thirteenth embodiments of the disclosure.

### DESCRIPTION OF THE EMBODIMENTS

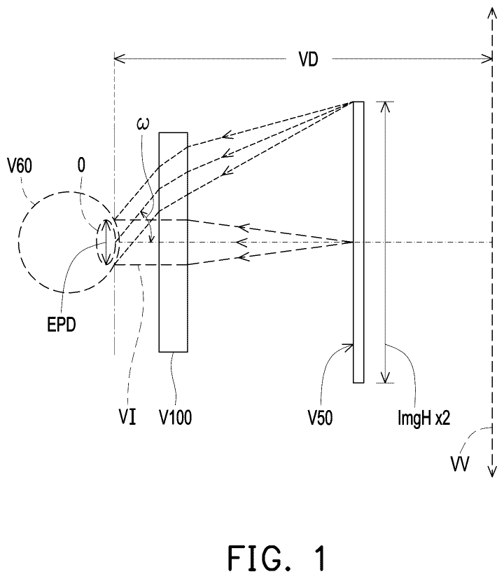

In general, a ray direction of an ocular optical system V100 refers to the following: imaging rays V1 are emitted by a display screen V50, enter an eye V60 via the ocular optical system V100, and are then focused on a retina of the eye V60 for imaging and generating an enlarged virtual image VV at a least distance of distinct vision VD, as depicted in FIG. 1. The following criteria for determining optical specifications of the present application are based on assumption that a reversely tracking of the ray direction is parallel imaging rays passing through the ocular optical system from an eye-side and focused on the display screen for imaging.

The terms “optical axis region”, “periphery region”, “concave”, and “convex” used in this specification and claims should be interpreted based on the definition listed in the specification by the principle of lexicographer.

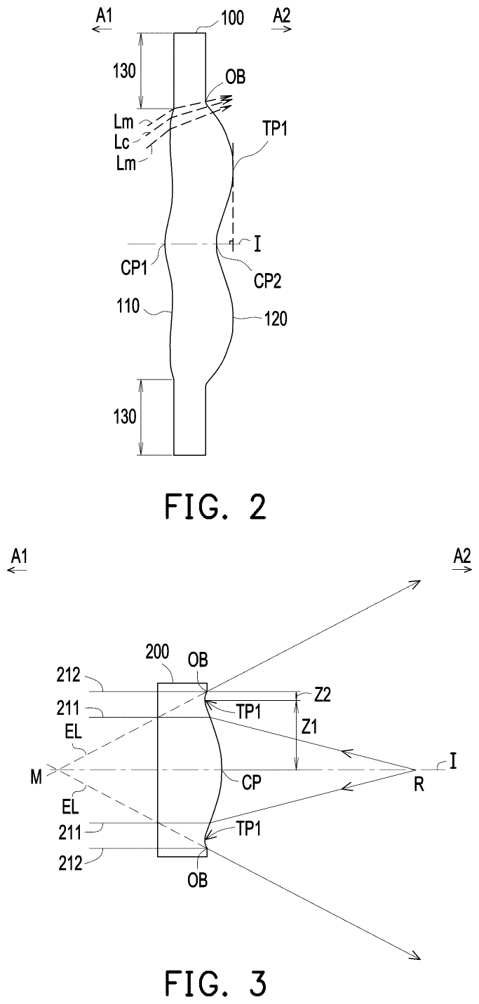

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an eye-side (or display-side) surface of a lens element” refers to a specific region of that surface of the lens element at which imaging rays can pass through that specific region. Imaging rays include at least two types of rays: a chief ray Lc and a marginal ray Lm (as shown in FIG. 2). An eye-side (or display-side) surface of a lens element can be characterized as having several regions, including an optical axis region, a periphery region, and, in some cases, one or more intermediate regions, as discussed more fully below.

FIG. 2 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 2, a first central point CP1 may be present on the eye-side surface 110 of lens element 100 and a second central point CP2 may be present on the display-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 5), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the display side A2 of the lens element. The shape of a region is concave if the extension line of a collimated ray being parallel to the optical axis I and passing through the region intersects the optical axis I on the eye side A1 of the lens element.

Additionally, referring to FIG. 2, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 3, optical axis region Z1 is defined between central point CP and first transition point TP1. Periphery region Z2 is defined between TP1 and the optical boundary OB of the surface of the lens element. Collimated ray 211 intersects the optical axis I on the display side A2 of lens element 200 after passing through optical axis region Z1, i.e., the focal point of collimated ray 211 after passing through optical axis region Z1 is on the display side A2 of the lens element 200 at point R in FIG. 3. Accordingly, since the ray itself intersects the optical axis I on the display side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the eye side A1 of lens element 200, i.e., the focal point of collimated ray 212 after passing through periphery region Z2 is on the eye side A1 at point M in FIG. 3. Accordingly, since the extension line EL of the ray intersects the optical axis I on the eye side A1 of the lens element 200, periphery region Z2 is concave. In the lens element 200 illustrated in FIG. 3, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and Code V. The R value usually appears in the lens data sheet in the software. For an eye-side surface, a positive R value defines that the optical axis region of the eye-side surface is convex, and a negative R value defines that the optical axis region of the eye-side surface is concave. Conversely, for a display-side surface, a positive R value defines that the optical axis region of the display-side surface is concave, and a negative R value defines that the optical axis region of the display-side surface is convex. The result found by using this method should be consistent with the method utilizing intersection of the optical axis by rays/extension lines mentioned above, which determines surface shape by referring to whether the focal point of a collimated ray being parallel to the optical axis I is on the eye-side or the display-side of a lens element. As used herein, the terms “a shape of a region is convex (concave),” “a region is convex (concave),” and “a convex-(concave-) region,” can be used alternatively.

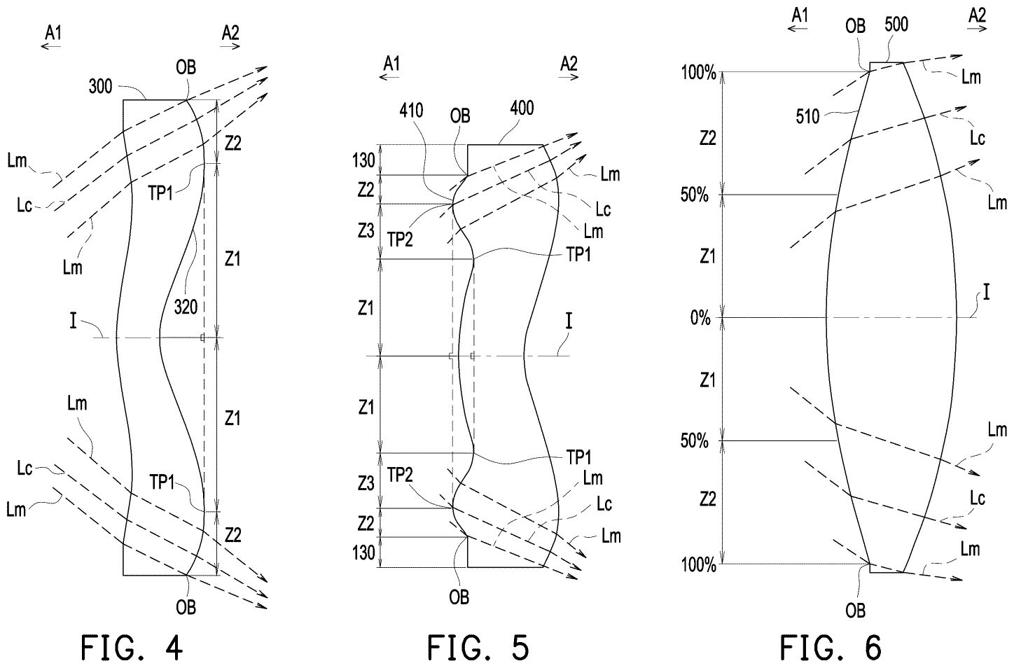

FIG. 4, FIG. 5 and FIG. 6 illustrate examples of determining the shape of lens element regions and the boundaries of regions under various circumstances, including the optical axis region, the periphery region, and intermediate regions as set forth in the present specification.

FIG. 4 is a radial cross-sectional view of a lens element 300. As illustrated in FIG. 4, only one transition point TP1 appears within the optical boundary OB of the display-side surface 320 of the lens element 300. Optical axis region Z1 and periphery region Z2 of the display-side surface 320 of lens element 300 are illustrated. The R value of the display-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 4, since the shape of the optical axis region Z1 is concave, the shape of the periphery region Z2 will be convex as the shape changes at the transition point TP1.

FIG. 5 is a radial cross-sectional view of a lens element 400. Referring to FIG. 5, a first transition point TP1 and a second transition point TP2 are present on the eye-side surface 410 of lens element 400. The optical axis region Z1 of the eye-side surface 410 is defined between the optical axis I and the first transition point TP1. The R value of the eye-side surface 410 is positive (i.e., R>0). Accordingly, the optical axis region Z1 is convex.

The periphery region Z2 of the eye-side surface 410, which is also convex, is defined between the second transition point TP2 and the optical boundary OB of the eye-side surface 410 of the lens element 400. Further, intermediate region Z3 of the eye-side surface 410, which is concave, is defined between the first transition point TP1 and the second transition point TP2. Referring once again to FIG. 5, the eye-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the eye-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 6 is a radial cross-sectional view of a lens element 500. Lens element 500 has no transition point on the eye-side surface 510 of the lens element 500. For a surface of a lens element with no transition point, for example, the eye-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 6, the optical axis region Z1 of the eye-side surface 510 is defined between the optical axis I and 50% of the distance between the optical axis I and the optical boundary OB. The R value of the eye-side surface 510 is positive (i.e., R>0). Accordingly, the optical axis region Z1 is convex. For the eye-side surface 510 of the lens element 500, because there is no transition point, the periphery region Z2 of the eye-side surface 510 is also convex. It should be noted that lens element 500 may have a mounting portion (not shown) extending radially outward from the periphery region Z2.

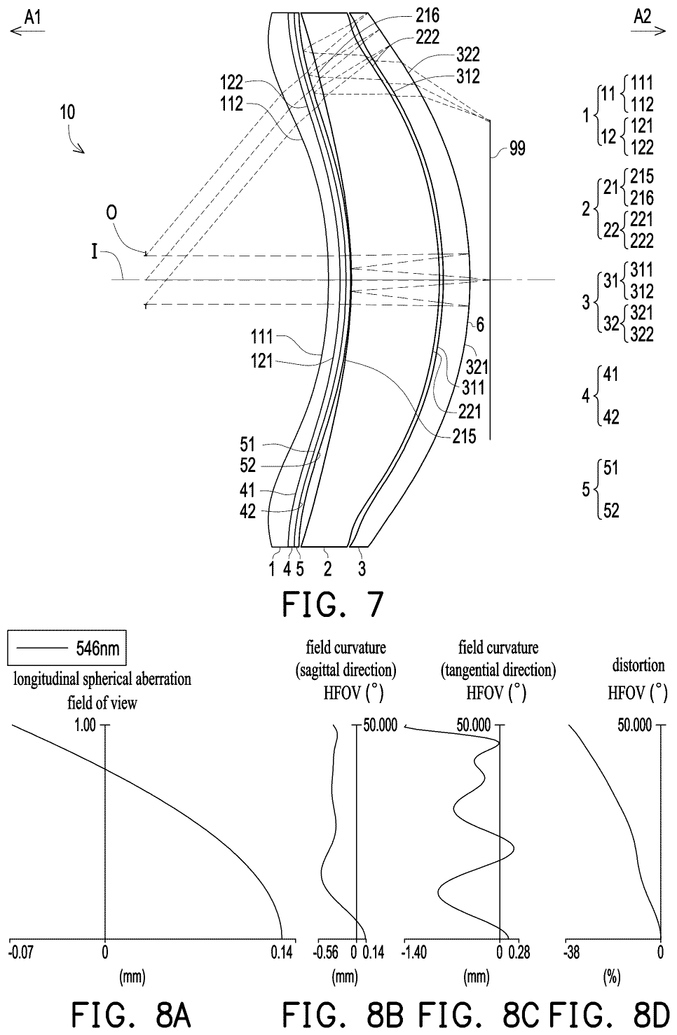

FIG. 7 is a schematic view illustrating an ocular optical system according to a first embodiment of the disclosure, and FIG. 8A to FIG. 8D are schematic views showing a longitudinal spherical aberration and other aberrations of the ocular optical system of the first embodiment. Referring to FIG. 7 first, the ocular optical system 10 of the first embodiment of the present disclosure includes a first lens element 1, a linear polarizing film plus a reflective polarizing film 4, a quarter-wave plate 5, a second lens element 2, a third lens element 3 and a partial mirror 6 arranged in sequence along an optical axis I of the ocular optical system 10 from an eye-side A1 to a display-side A2. An image is formed when the ray emitted by a display screen (display screen 99 as shown in FIG. 7) enters an eye (the pupil 0 of the observer as shown in FIG. 7) through the ocular optical system 10, and this image is an enlarged virtual image.

In the embodiment, the first lens element 1, the second lens element 2, the third lens element 3, the linear polarizing film plus reflective polarizing film 4 and the quarter-wave plate 5 each have an eye-side surface 11, 21, 31, 41 and 51 facing the eye-side A1 and allowing the imaging ray to pass through, and a display-side surface 12, 22, 32, 42 and 52 facing the display-side A2 and allowing the imaging ray to pass through. In this embodiment, the first lens element 1 is placed between the pupil 0 and the second lens element 2.

In this embodiment, the first lens element 1 has positive refracting power. The optical axis region 111 and the periphery region 112 of the eye-side surface 11 of the first lens element 1 are both concave, and the optical axis region 121 and the periphery region 122 of the display-side surface 12 are both convex.

The second lens element 2 has positive refracting power. The optical axis region 215 and the periphery region 216 of the eye-side surface 21 of the second lens element 2 are both concave, and the optical axis region 221 and the periphery region 222 of the display-side surface 22 are both convex.

The third lens element 3 has negative refracting power. The optical axis region 311 and the periphery region 312 of the eye-side surface 31 of the third lens element 3 are both concave, and the optical axis region 321 and the periphery region 322 of the display-side surface 32 are both convex.

The reflective polarizing film is disposed on the linear polarizing film, and they altogether are represented as linear polarizing film and reflective polarizing film 4 in subsequent illustrations. The linear polarizing film is disposed on the convex surface of the optical axis region 121 of the display-side surface 12 of the first lens element 1 to reflect the imaging ray with one of the linear polarization states and allow the imaging ray with the other linear polarization state to pass through. Furthermore, the linear polarizing film and reflective polarizing film 4 may be directly disposed on the entire display-side 12 of the first lens element 1.

The quarter-wave plate 5 is disposed on the reflective polarizing film. Specifically, in the direction of the optical axis I, the quarter-wave plate 5 is disposed between the linear polarizing film and the reflective polarizing film 4 and the second lens element 2. The quarter-wave plate 5 is configured to convert an imaging ray in a circularly polarized state into an imaging ray in a linearly polarized state, or to convert an imaging ray in a linearly polarized state into an imaging ray in a circularly polarized state. From another perspective, the quarter-wave plate 5 is disposed between the display-side surface 12 of the first lens element 1 and the eye-side surface 21 of the second lens element 2.

On the other hand, the partial mirror 6 is disposed on the display-side surface 32 of the third lens element 3 to reflect part of the energy of the imaging ray. Furthermore, in this embodiment, the partial mirror 6 is disposed on the optical axis region 321, but the disclosure is not limited thereto. The partial mirror 6 has an average optical reflectance of at least 30% in the desired plurality of wavelengths, and in this embodiment the partial mirror 6 is a half-mirror.

In this embodiment, the eye-side surfaces 11, 21, 31 and the display-side surfaces 12, 22, 32 are all aspheric surfaces, so the linear polarizing film and reflective polarizing film 4 disposed on the display-side surface 12 and the quarter-wave plate 5 are substantially disposed conformally with the display-side surface 12, so they may also be aspheric surfaces. From another perspective, the eye-side surfaces 41 and 51 and the display-side surfaces 42 and 52 may also be aspheric surfaces. Similarly, the partial mirror 6 disposed on the display-side surface 32 may also be an aspheric surface.

In detail, in the present embodiment, the display screen (shown as display screen 99 in FIG. 7) provides imaging rays with one state of circularly polarized states and passed through the third lens element 3 and the second lens element 2 to the quarter-wave plate 5 to form imaging rays with one state of linearly polarized states. The imaging rays with the one state of linearly polarized states is transmitted to the linear polarizing film and the reflective polarizing film 4, and is reflected out as the imaging ray with the one state of linearly polarized states. The imaging rays with the one state of linearly polarized states passed through the quarter-wave plate 5 again to form imaging rays with another one state of circularly polarized states. After the imaging ray with the another one state of circularly polarized states passes through the second lens element 2 and the third lens element 3, the imaging ray is transmitted to the display-side surface 32 of the third lens element 3 including the partial mirror 6, and reflected out as the imaging ray with the another one state of circularly polarized states. After the imaging ray with the another one state of circularly polarized states passes through the third lens element 3 and the second lens element 2 again, the imaging ray is transmitted to the quarter-wave plate 5 to form the imaging ray with another one state of linearly polarized states. Finally, the imaging ray with the another one state of linearly polarized states passes through the linear polarizing film and the reflective polarizing film 4, and then is transmitted to the first lens element 1 to enter an eye of an observer (shown as pupil 0 of observer in FIG. 7) to form an enlarged virtual image.

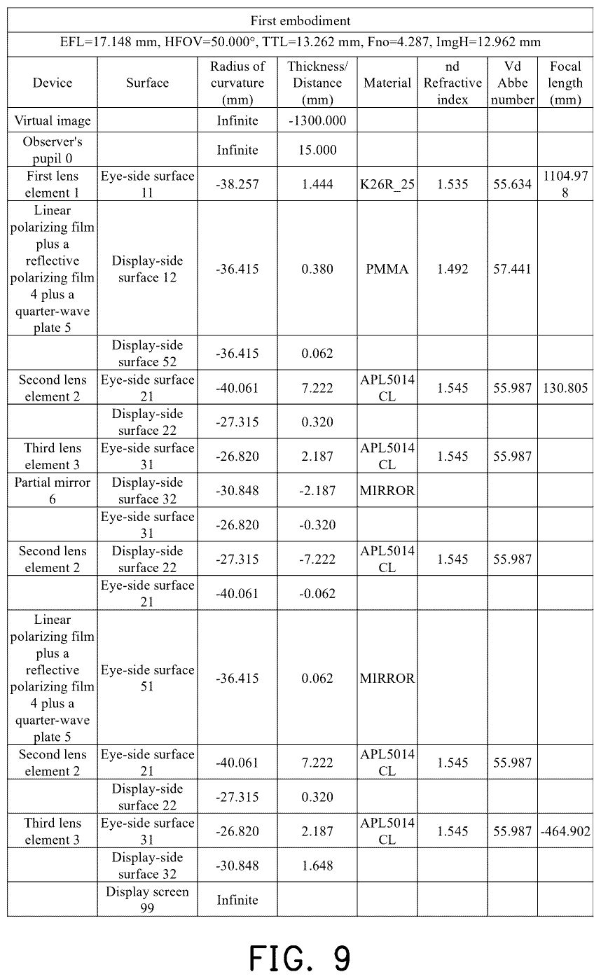

Other detailed optical data of the first embodiment are shown in FIG. 9, and the effective focal length (EFL) of the ocular optical system 10 of the first embodiment is 17.148 mm, and the half field of view (HFOV) is 50.000 degrees, TTL is 13.262 mm, F-number (Fno) is 4.287, and maximum image height (ImgH) is 12.962 mm, wherein TTL refers to the distance on the optical axis I from the eye-side surface 11 of the first lens element 1 to the display screen 99. It is worth mentioning that in FIG. 9 and the embodiments described later, the thickness or distance in the Table has directionality, wherein the direction of rays toward the eye-side A1 is defined as positive, and the direction of rays toward the display-side A2 is defined as negative.

In addition, in this embodiment, the eye-side surfaces 11, 21, 31, 41, 51 and the display-side surfaces 12, 22, 32, 42, 52 among the aspheric surfaces are general even aspheric surfaces. These aspheric surfaces are defined according to the following formula (1):

$$Z ( Y ) = \frac{{Y}^{2}}{R} / ( 1 + \sqrt{1 + ( 1 + K ) \frac{{Y}^{2}}{{R}^{2}}} ) + {\sum }_{i = 1}^{n} {a}_{i} \times {Y}^{i} \qquad ( 1 )$$

wherein:
R: a radius of curvature of the surface of the lens element close to the optical axis I;
Z: a depth of the aspheric surface (a perpendicular distance between the point on the aspheric surface that is spaced by the distance Y from the optical axis I and a tangent plane tangent to a vertex of the aspheric surface on the optical axis I);
Y: a perpendicular distance between a point on an aspheric curve and the optical axis I;
K: a conic constant; and
aᵢ: i^{th} aspheric coefficient.

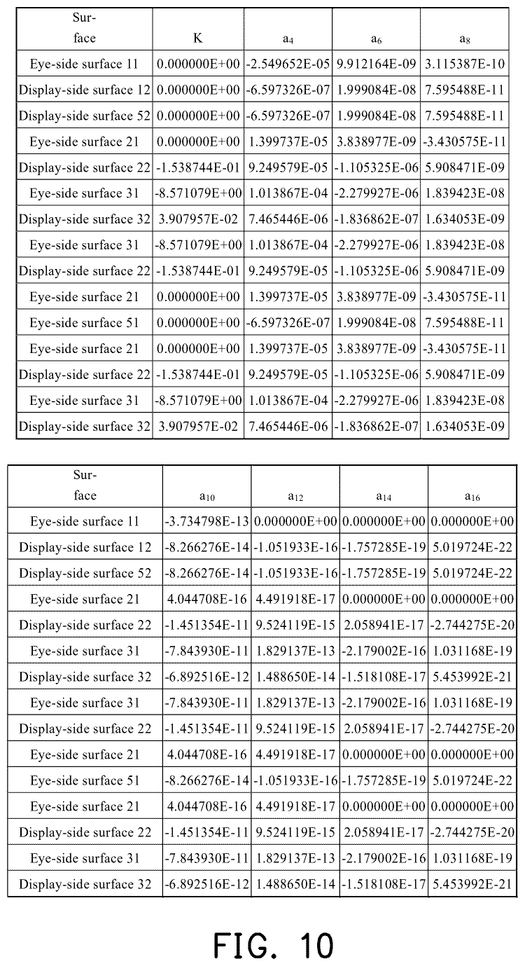

The aspheric coefficients of the eye-side surfaces and the display-side surfaces of the abovementioned elements are as shown in FIG. 10. In this embodiment and the following embodiments, the second-order aspheric coefficient a₂ of each aspheric surface is all zero. Therefore, the expression of aspheric coefficient a₂ is omitted from the Table.

In addition, the “inflection point” of the above-mentioned aspheric surface is defined as the Y value when finding the second derivative of the function Z (Y) in formula (1) being equal to 0. The point where the Y value is located is the inflection point, that is, the inflection point is a point on the aspheric surface, and the distance from the inflection point to the optical axis I is the Y value.

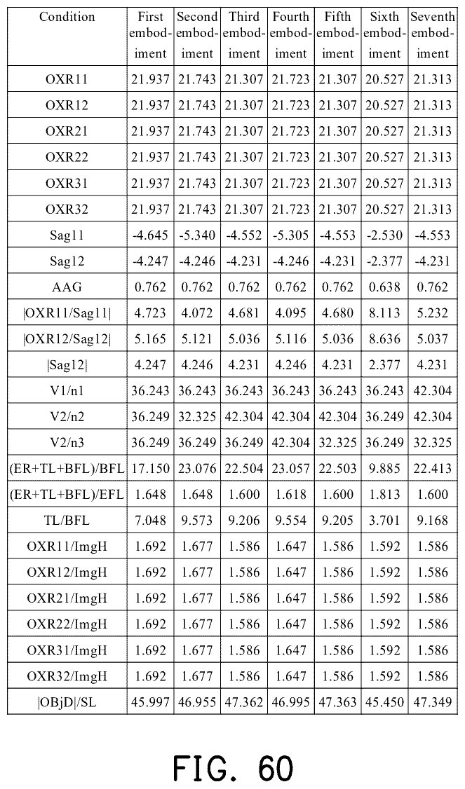

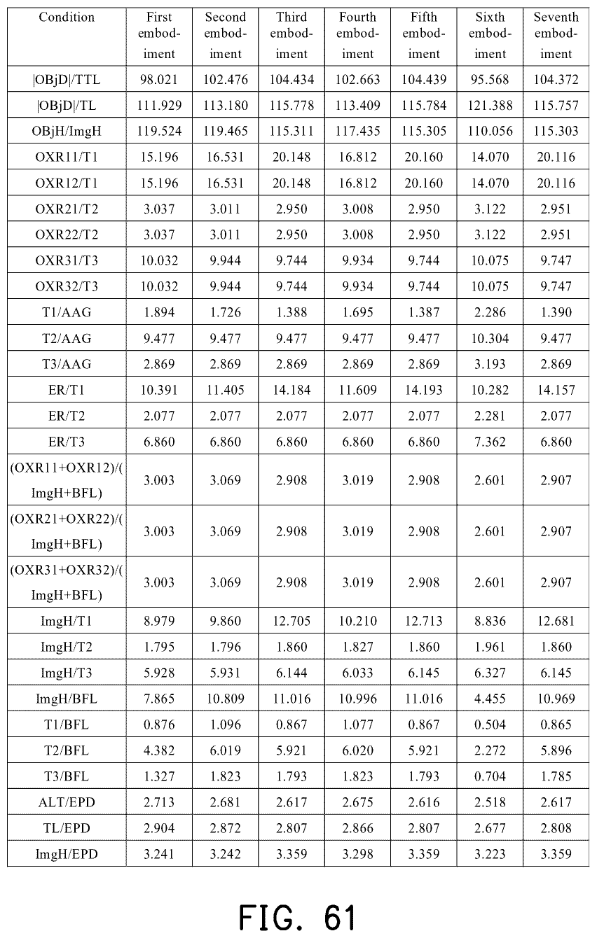

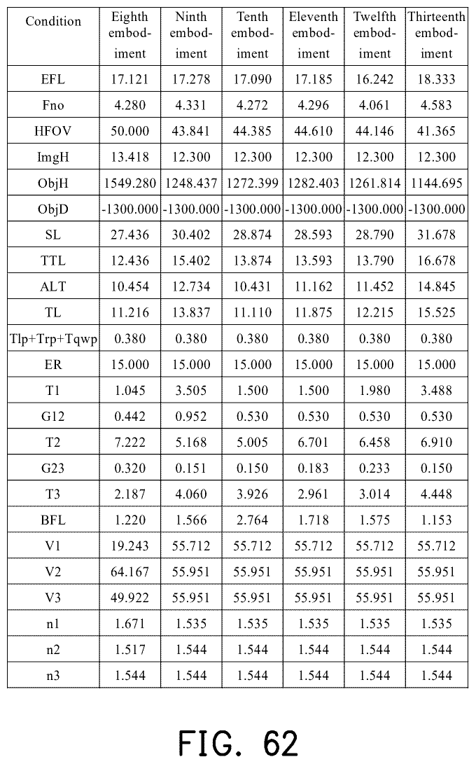

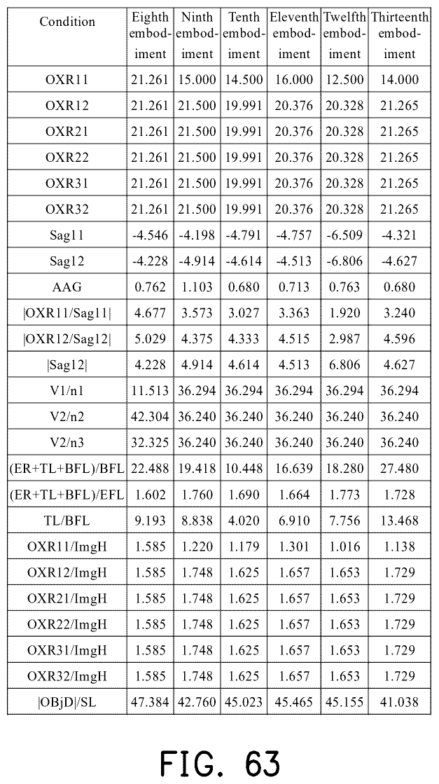

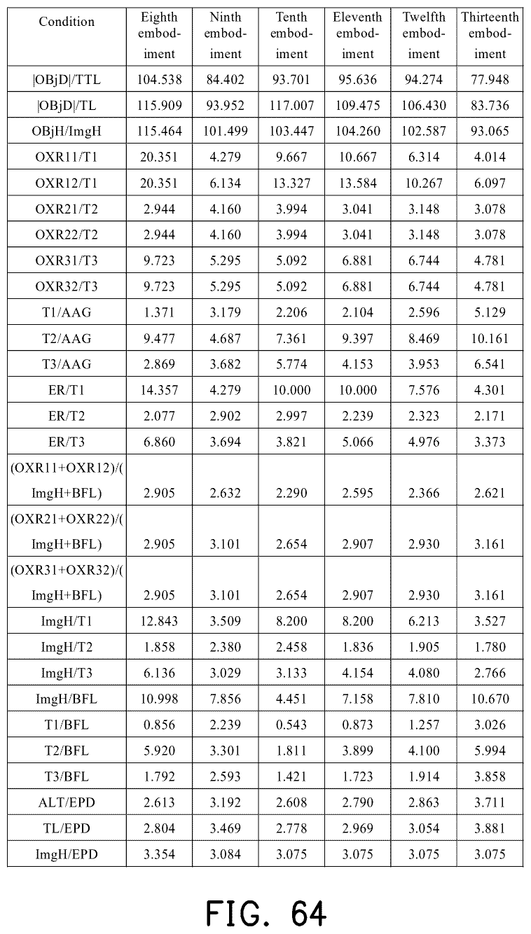

On the other hand, FIG. 59 to FIG. 61 show values of relational expressions of important parameters of the ocular optical systems of the first to seventh embodiments of the disclosure. FIG. 62 to FIG. 64 show values of relational expressions of important parameters of the ocular optical systems of the eighth to thirteenth embodiments of the disclosure. The relationship between important parameters in the ocular optical system 10 of the first embodiment are as shown in FIG. 59 to FIG. 61,

where
EFL is an effective focal length of the ocular optical system 10;
Fno is an F-number of the ocular optical system 10;
HFOV is a half field of view, which is the maximum angle of half of the visual field of the observer;
ImgH is a maximum image height of the ocular optical system 10, which is half of the ICD (Image circle diameter);
ObjH is a maximum height of the virtual image generated by the ocular optical system 10;
ObjD is a distance on the optical axis I from the pupil 0 of the observer to the virtual image generated by the ocular optical system 10;
SL is a system length of the ocular optical system 10, a distance on the optical axis I from the pupil 0 of the observer to the display screen 99;
ALT is a sum of thicknesses of the first lens element 1, the second lens element 2 and the third lens element 3 on the optical axis I, i.e., a sum of the thicknesses T1, T2, and T3;
TL is a distance from the eye-side surface 11 of the first lens element 1 to the display-side surface 32 of the third lens element 3 on the optical axis I;
Tlp+Trp+Tqwp is a sum of thicknesses of the linear polarizing film and the reflective polarizing film 4 as well as the quarter-wave plate 5 on the optical axis I;
ER (Eye relief) is an exit pupil distance, which is the distance from the pupil 0 of the observer to the first lens element 1 on the optical axis I;
T1 is a thickness of the first lens element 1 on the optical axis I;
T2 is a thickness of the second lens element 2 on the optical axis I;
T3 is a thickness of the third lens element 3 on the optical axis I;
G12 is a distance from the display-side surface 12 of the first lens element 1 to the eye-side surface 21 of the second lens element 2 on the optical axis I;
G23 is a distance from the display-side surface 22 of the second lens element 2 to the eye-side surface 31 of the third lens element 3 on the optical axis I;
BFL is a distance from the display-side surface 32 of the third lens element 3 to the display screen 99 on the optical axis I;
V1 is a VD Abbe number of the first lens element 1;
V2 is a VD Abbe number of the second lens element 2;
V3 is a VD Abbe number of the third lens element 3;
n1 is an nd refractive index of the first lens element 1;
n2 is an nd refractive index of the second lens element 2;
n3 is an nd refractive index of the third lens element 3;
OXR11 is an optical maximum radius of the eye-side surface 11 of the first lens element 1;
OXR12 is an optical maximum radius of the display-side surface 12 of the first lens element 1;
OXR21 is an optical maximum radius of the eye-side surface 21 of the second lens element 2;
OXR22 is an optical maximum radius of the display-side surface 22 of the second lens element 2;
OXR31 is an optical maximum radius of the eye-side surface 31 of the third lens element 3;
OXR32 is an optical maximum radius of the display-side surface 32 of the third lens element 3;
Sag11 is a Sag value of the eye-side surface 11 of the first lens element 1 on the optical maximum radius, wherein Sag is a depth of the aspheric surface calculated through an aspheric formula (a perpendicular distance between the point on the aspheric surface that is spaced by the distance Y from the optical axis I and a tangent plane tangent to a vertex of the aspheric surface on the optical axis I);
Sag12 is a Sag value of the display-side surface 12 of the first lens element 1 on the optical maximum radius;
AAG is a sum of a distance on the optical axis I from the display-side surface 12 of the first lens element 1 to the eye-side surface 21 of the second lens element 2 and a distance on the optical axis I from the display-side surface 22 of the second lens element 2 to the eye-side surface 31 of the third lens element 3, i.e., G12+G23;
EPD (Exit pupil diameter) is an exit pupil diameter of the ocular optical system 10, which corresponds to the diameter of the pupil 0 of the observer and is equal to EFL/Fno.

Furthermore, it is defined that:
f1 is a focal length of the first lens element 1;
f2 is a focal length of the second lens element 2;
f3 is a focal length of the third lens element 3.

It should be noted that f1, f2, f3 and EFL are the values calculated for the material at a wavelength of 546 nm; n1, n2, n3, V1, V2 and V3 are Vd and nd values of disclosure materials in accordance with the format of the International Glass Code. It is worth mentioning that in this embodiment, in the radial direction of the second lens element 2, there are two inflection points from the optical axis I to the optical maximum radius of the display-side surface 22 of the second lens element 2. The setting of the inflection point may reduce the degree of change in the surface shape Sag of the first lens element 1 while increasing the half field of view.

Then, reference may be made to FIG. 8A to FIG. 8D in conjunction. FIG. 8A is a diagram showing longitudinal spherical aberrations on the display screen 99 at a representative wavelength of 546 nm of the first embodiment. FIG. 8B and FIG. 8C are respectively diagrams showing field curvature aberrations in a sagittal direction and a tangential direction on the display screen 99 at a wavelength of 546 nm of the first embodiment. FIG. 8D is a diagram showing distortion aberrations on the display screen 99 at a wavelength of 546 nm of the first embodiment. The longitudinal spherical aberrations of the first embodiment are as shown in FIG. 8A. Curves formed by the wavelengths are very close to each other and are close to the middle, which indicates that off-axis rays at different heights at each wavelength and are concentrated near an imaging point. As can be seen from the deflection amplitude of the curve at each wavelength, deviations of imaging points of the off-axis rays at different heights are controlled within a range of ±0.14 mm. Therefore, in the first embodiment, the spherical aberration of the same wavelength is obviously improved.

In the two diagrams of FIG. 8B and FIG. 8C showing field curvature aberrations, changes in focal lengths of the representative wavelengths within the entire field of view fall within ±1.4 mm, which indicates that the optical system of the first embodiment can effectively alleviate the optical aberrations. The distortion aberration diagram of FIG. 8D shows that the distortion aberrations of this embodiment are maintained within a range of ±38%, which indicates that the distortion aberrations of the first embodiment meet the imaging quality requirements of the optical system. It is accordingly indicated that, compared with an existing optical lens, the first embodiment can still provide good imaging quality under the condition that TTL has been reduced to 13.262 mm. Thus, the first embodiment can have a relatively large F-number, a higher image height and good imaging quality in a case where good optical performance is maintained.

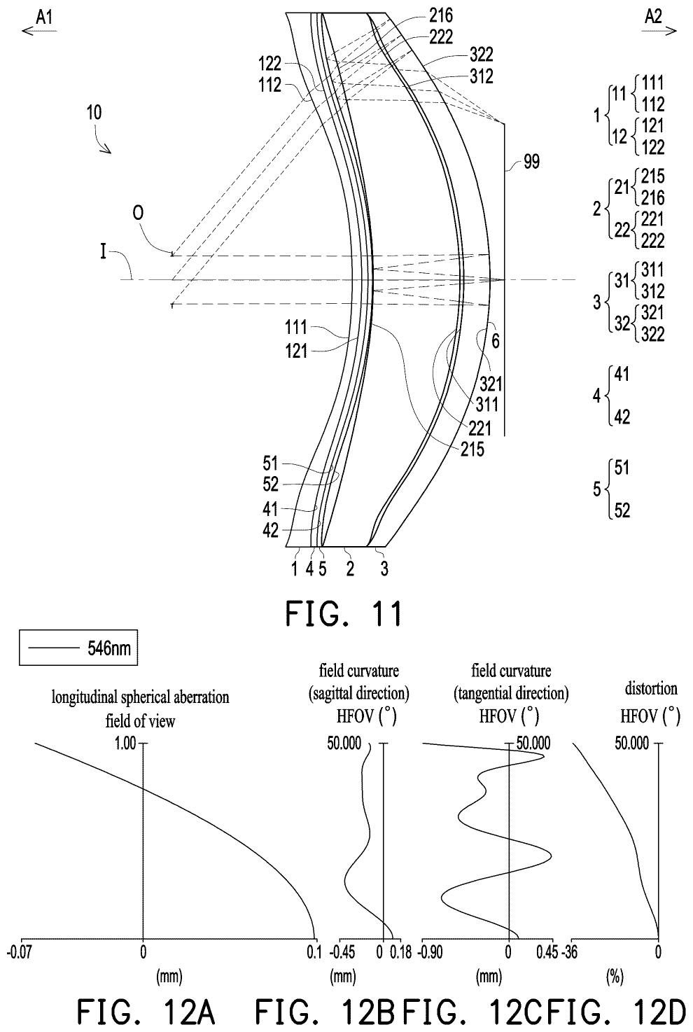

FIG. 11 is a schematic diagram of an ocular optical system according to the second embodiment of the present disclosure. FIG. 12A to FIG. 12D are diagrams of longitudinal spherical aberrations and various optical aberrations of the ocular optical system of the second embodiment of the disclosure. Please refer to FIG. 11 first. The second embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2 and the third lens element 3.

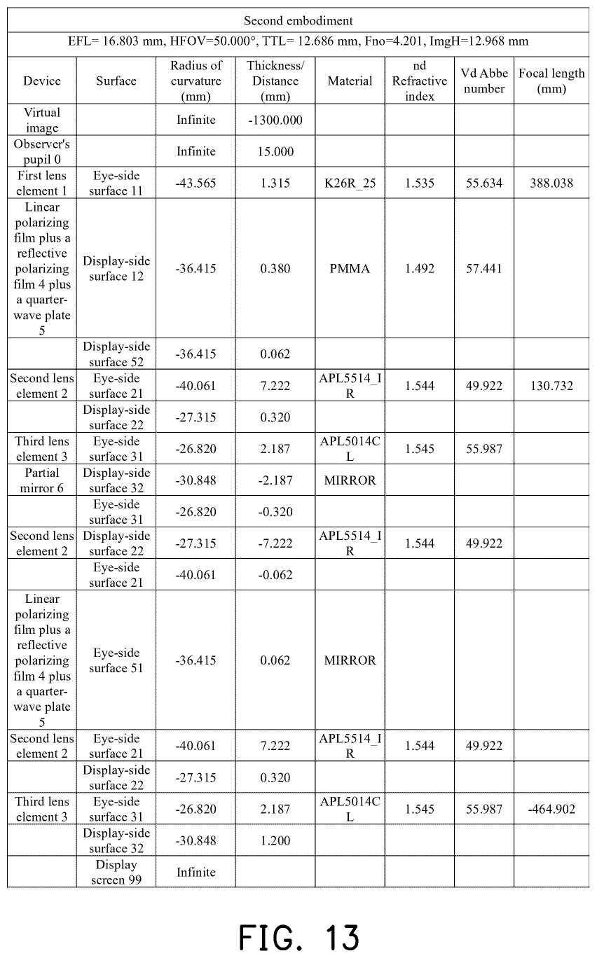

The detailed optical data of the ocular optical system 10 of the second embodiment is shown in FIG. 13, and the EFL of the ocular optical system 10 of the second embodiment is 16.803 mm, the HFOV is 50.000 degrees, the TTL is 12.686 mm, the Fno is 4.201, and the ImgH is 12.968 mm.

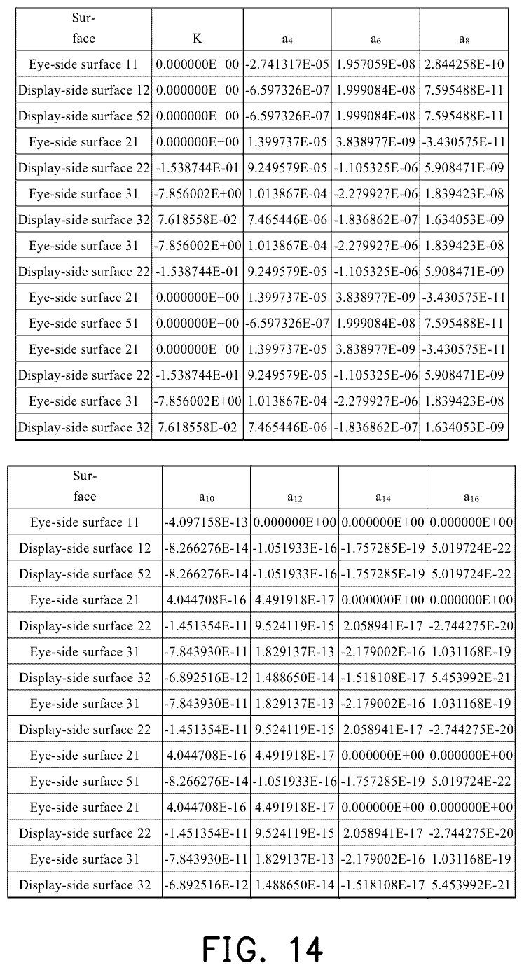

FIG. 14 also shows aspheric coefficients of the eye-side surfaces 11, 21, 31, 41 and 51 and the display-side surfaces 12, 22, 32, 42 and 52 of the second embodiment in the above formula (1).

In addition, the relationship between the important parameters in the ocular optical system 10 of the second embodiment is shown in FIG. 59 to FIG. 61.

FIG. 12A shows the longitudinal spherical aberrations of the second embodiment. The deviations of imaging points of the off-axis rays at different heights are controlled within a range of ±0.1 mm. In the two diagrams of FIG. 12B and FIG. 12C showing field curvature aberrations, the changes in focal lengths of the representative wavelengths within the entire field of view fall within +0.9 mm. The distortion aberration diagram of FIG. 12D shows that the distortion aberrations of this embodiment are maintained within a range of ±36%.

From the above description, it can be known that the length TTL of the ocular optical system 10 of the second embodiment is shorter than that of the first embodiment, so the second embodiment may have a smaller size. The aperture and image height of the second embodiment are also slightly greater than those of the first embodiment, which also shows that the second embodiment has better sensitivity. In addition, the second embodiment has more preferable field curvature, distortion and longitudinal spherical aberrations than the first embodiment, and has improved imaging quality.

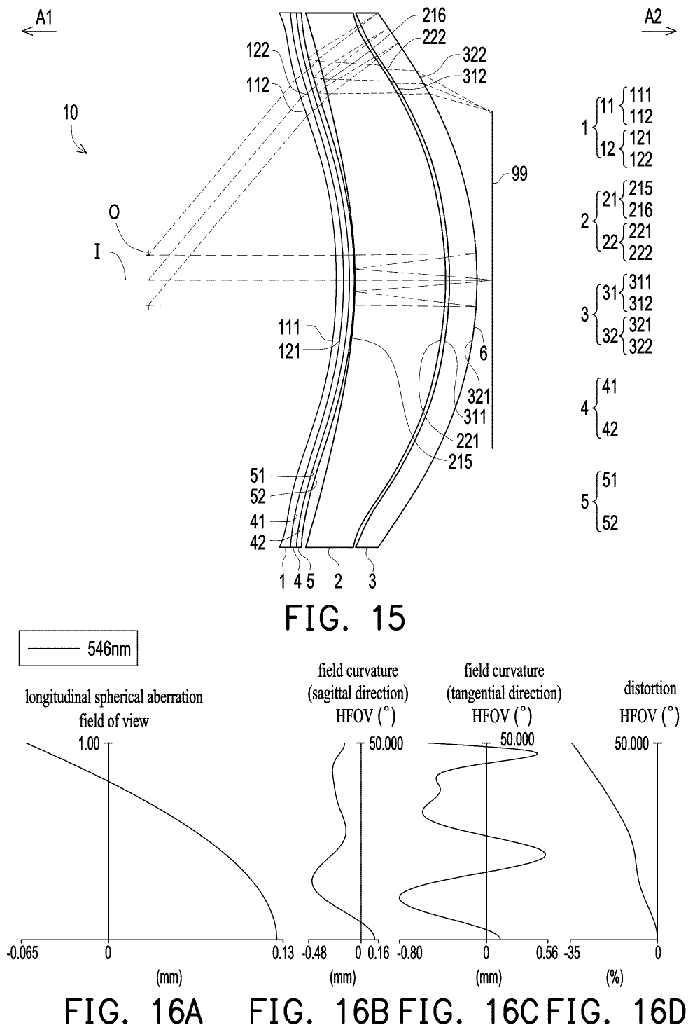

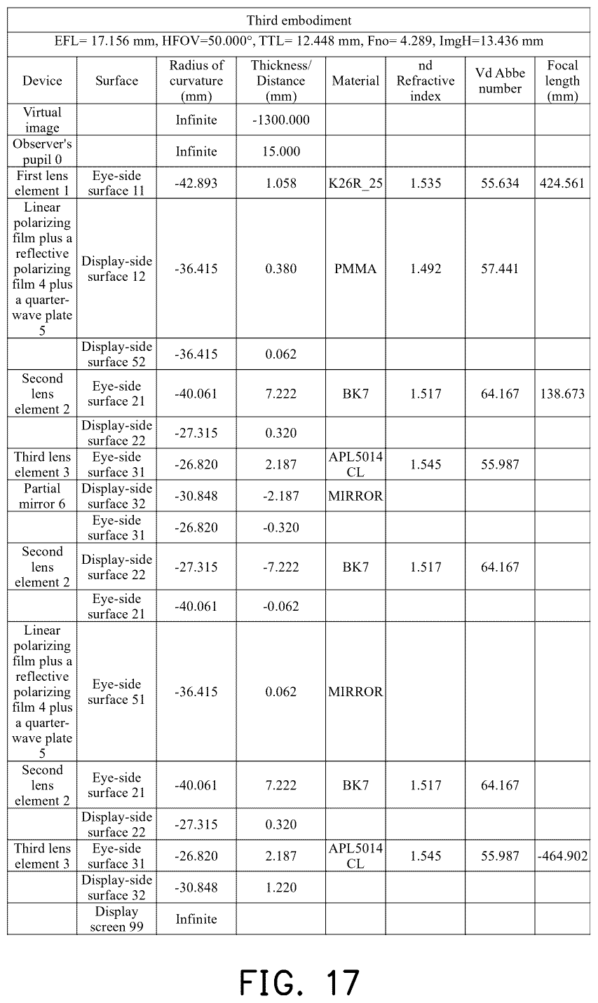

FIG. 15 is a schematic diagram of an ocular optical system according to the third embodiment of the present disclosure. FIG. 16A to FIG. 16D are diagrams of longitudinal spherical aberrations and various optical aberrations of the ocular optical system of the third embodiment of the disclosure. Please refer to FIG. 15 first. The third embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5.

The detailed optical data of the ocular optical system 10 of the third embodiment is shown in FIG. 17, and the EFL of the ocular optical system 10 of the third embodiment is 17.156 mm, the HFOV is 50.000 degrees, the TTL is 12.448 mm, the Fno is 4.289, and the ImgH is 13.436 mm.

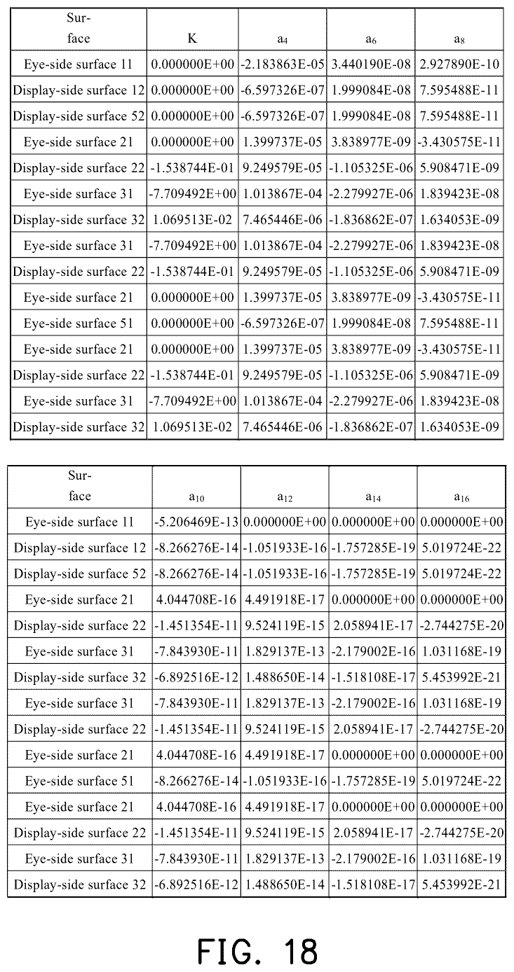

FIG. 18 also shows aspheric coefficients of the eye-side surfaces 11, 21, 31, 41 and 51 and the display-side surfaces 12, 22, 32, 42 and 52 of the third embodiment in the above formula (1).

In addition, the relationship between the important parameters in the ocular optical system 10 of the third embodiment is shown in FIG. 59 to FIG. 61.

FIG. 16A shows the longitudinal spherical aberrations of the third embodiment. The deviations of imaging points of the off-axis rays at different heights are controlled within a range of ±0.13 mm. In the two diagrams of FIG. 16B and FIG. 16C showing field curvature aberrations, the changes in focal lengths of the representative wavelengths within the entire field of view fall within ±0.8 mm. The distortion aberration diagram of FIG. 16D shows that the distortion aberrations of this embodiment are maintained within a range of ±35%.

From the above description, it can be known that the length TTL of the ocular optical system 10 of the third embodiment is shorter than that of the first embodiment, so the third embodiment may have a smaller size. The image height of the third embodiment is also slightly higher than that of the first embodiment. In addition, the third embodiment has more preferable field curvature and longitudinal spherical aberrations than the first embodiment, and has improved imaging quality.

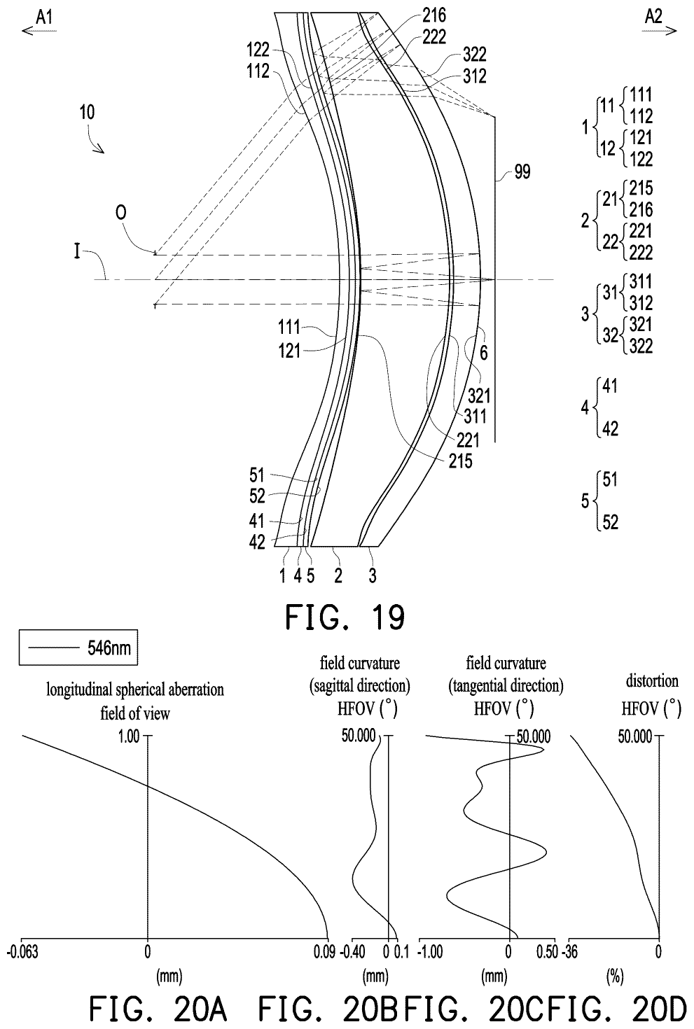

FIG. 19 is a schematic diagram of an ocular optical system according to the fourth embodiment of the present disclosure. FIG. 20A to FIG. 20D are diagrams of longitudinal spherical aberrations and various optical aberrations of the ocular optical system of the fourth embodiment of the disclosure. Please refer to FIG. 19 first. The fourth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5.

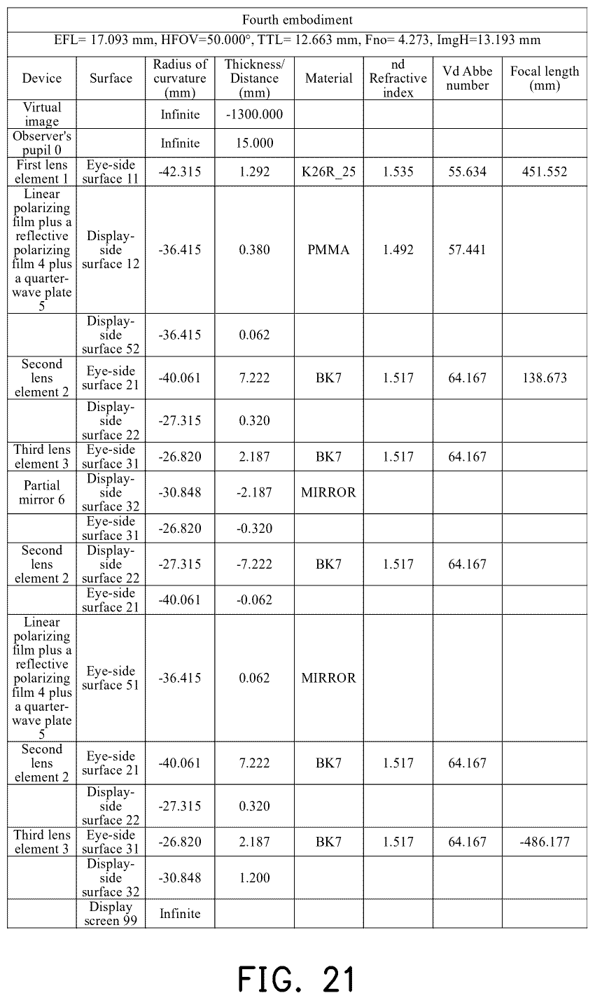

The detailed optical data of the ocular optical system 10 of the fourth embodiment is shown in FIG. 21, and the EFL of the ocular optical system 10 of the fourth embodiment is 17.093 mm, the HFOV is 50.000 degrees, the TTL is 12.663 mm, the Fno is 4.273, and the ImgH is 13.193 mm.

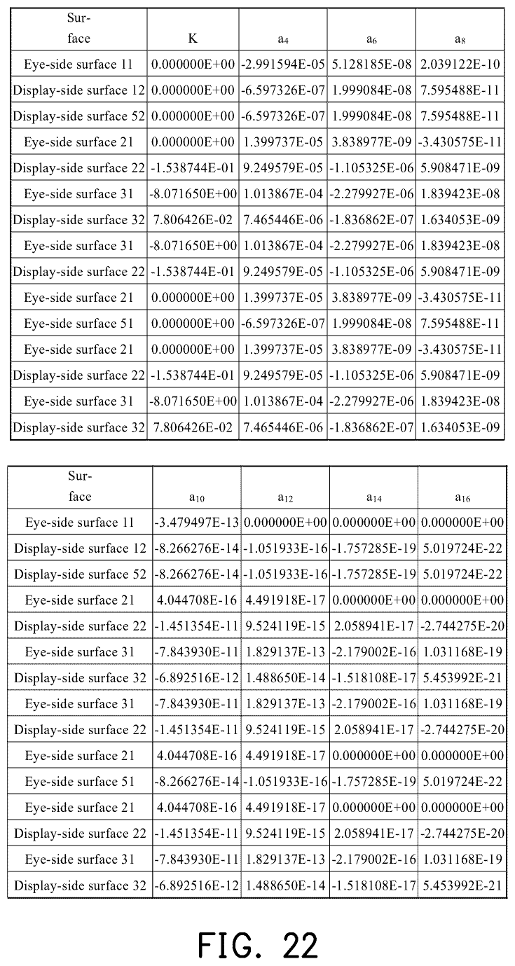

FIG. 22 also shows aspheric coefficients of the eye-side surfaces 11, 21, 31, 41 and 51 and the display-side surfaces 12, 22, 32, 42 and 52 of the fourth embodiment in the above formula (1).

In addition, the relationship between the important parameters in the ocular optical system 10 of the fourth embodiment is shown in FIG. 59 to FIG. 61.

FIG. 20A shows the longitudinal spherical aberrations of the fourth embodiment. The deviations of imaging points of the off-axis rays at different heights are controlled within a range of ±0.09 mm. In the two diagrams of FIG. 20B and FIG. 20C showing field curvature aberrations, the changes in focal lengths of the representative wavelengths within the entire field of view fall within +1.0 mm. The distortion aberration diagram of FIG. 20D shows that the distortion aberrations of this embodiment are maintained within a range of ±36%.

From the above description, it can be known that the length TTL of the ocular optical system 10 of the fourth embodiment is shorter than that of the first embodiment, so the third embodiment may have a smaller size. The aperture and image height of the fourth embodiment are also slightly greater than those of the first embodiment. It may be said that the fourth embodiment has better sensitivity. In addition, the fourth embodiment has more preferable field curvature, distortion and longitudinal spherical aberrations than the first embodiment, and has improved imaging quality.

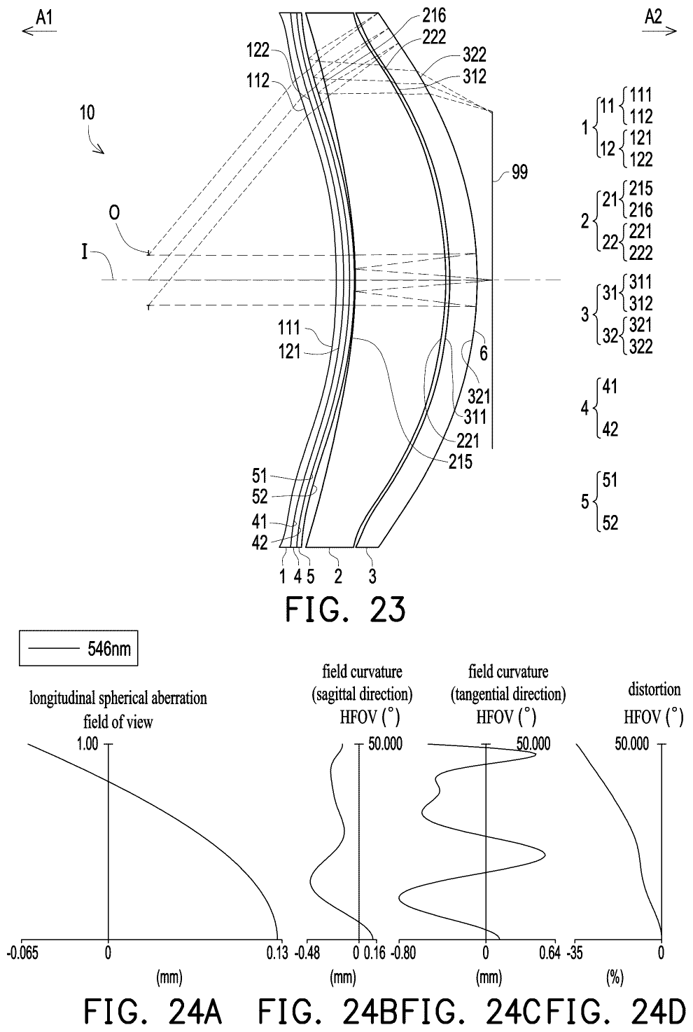

FIG. 23 is a schematic diagram of an ocular optical system according to the fifth embodiment of the present disclosure. FIG. 24A to FIG. 24D are diagrams of longitudinal spherical aberrations and various optical aberrations of the ocular optical system of the fifth embodiment of the disclosure. Please refer to FIG. 23 first. The fifth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5.

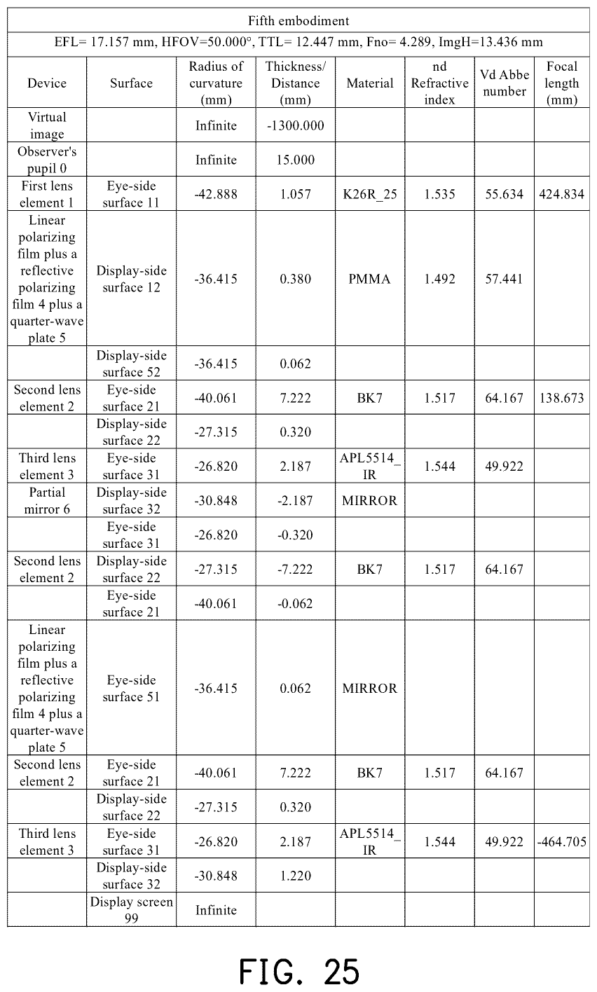

The detailed optical data of the ocular optical system 10 of the fifth embodiment is shown in FIG. 25, and the EFL of the ocular optical system 10 of the fifth embodiment is 17.157 mm, the HFOV is 50.000 degrees, the TTL is 12.447 mm, the Fno is 4.289, and the ImgH is 13.436 mm.

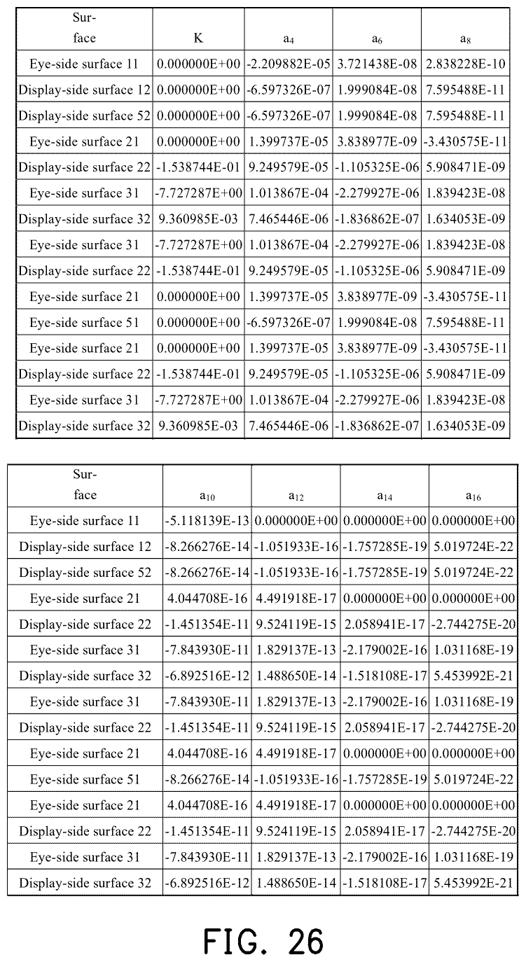

FIG. 26 also shows aspheric coefficients of the eye-side surfaces 11, 21, 31, 41 and 51 and the display-side surfaces 12, 22, 32, 42 and 52 of the fifth embodiment in the above formula (1).

In addition, the relationship between the important parameters in the ocular optical system 10 of the fifth embodiment is shown in FIG. 59 to FIG. 61.

FIG. 24A shows the longitudinal spherical aberrations of the fifth embodiment. The deviations of imaging points of the off-axis rays at different heights are controlled within a range of ±0.13 mm. In the two diagrams of FIG. 24B and FIG. 24C showing field curvature aberrations, the changes in focal lengths of the representative wavelengths within the entire field of view fall within +0.8 mm. The distortion aberration diagram of FIG. 24D shows that the distortion aberrations of this embodiment are maintained within a range of ±35%.

From the above description, it can be known that the length TTL of the ocular optical system 10 of the fifth embodiment is shorter than that of the first embodiment, so the fifth embodiment may have a smaller size. The image height of the fifth embodiment is also slightly higher than that of the first embodiment. In addition, the fifth embodiment has more preferable field curvature, distortion and longitudinal spherical aberrations than the first embodiment, and has improved imaging quality.

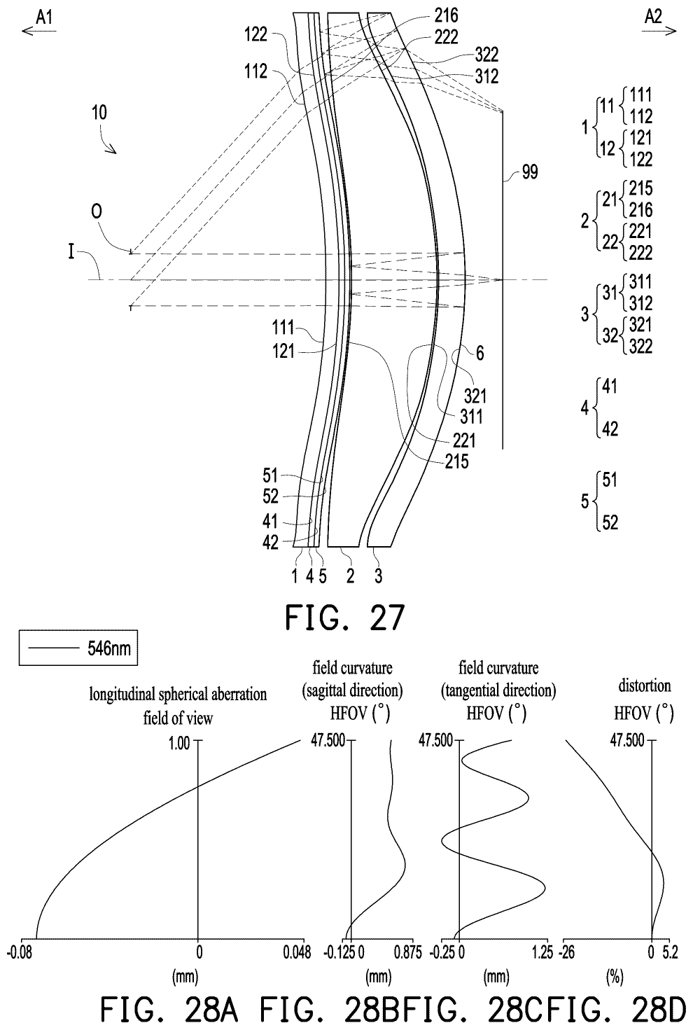

FIG. 27 is a schematic diagram of an ocular optical system according to the sixth embodiment of the present disclosure. FIG. 28A to FIG. 28D are diagrams of longitudinal spherical aberrations and various optical aberrations of the ocular optical system of the sixth embodiment of the disclosure. Please refer to FIG. 27 first. The sixth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5. In addition, in this embodiment, in the radial direction of the second lens element 2, there is an inflection point between the optical axis I and the optical maximum radius of the display-side surface 22 of the second lens element 2.

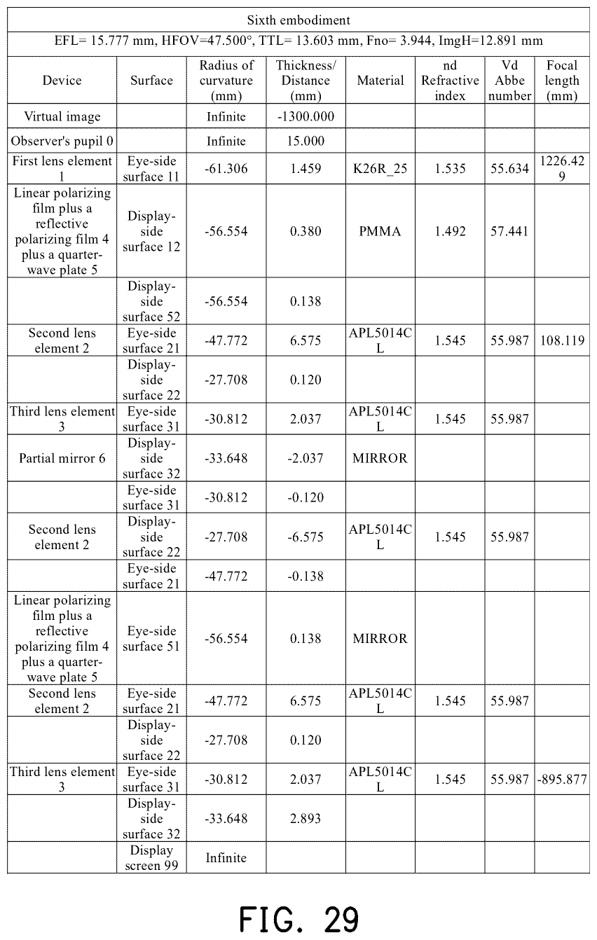

The detailed optical data of the ocular optical system 10 of the sixth embodiment is shown in FIG. 29, and the EFL of the ocular optical system 10 of the sixth embodiment is 15.777 mm, the HFOV is 47.500 degrees, the TTL is 13.603 mm, the Fno is 3.944, and the ImgH is 12.891 mm.

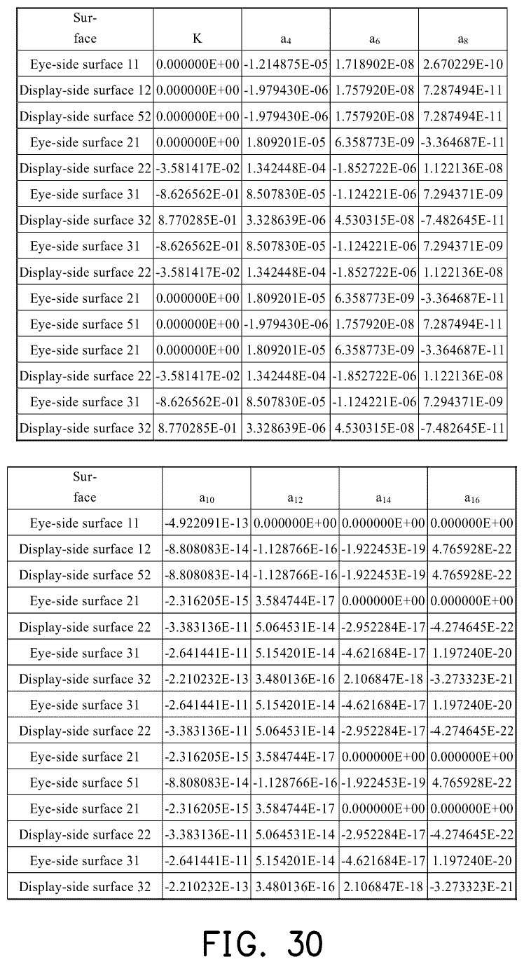

FIG. 30 also shows aspheric coefficients of the eye-side surfaces 11, 21, 31, 41 and 51 and the display-side surfaces 12, 22, 32, 42 and 52 of the sixth embodiment in the above formula (1).

In addition, the relationship between the important parameters in the ocular optical system 10 of the sixth embodiment is shown in FIG. 59 to FIG. 61.

FIG. 28A shows the longitudinal spherical aberrations of the sixth embodiment. The deviations of imaging points of the off-axis rays at different heights are controlled within a range of ±0.08 mm. In the two diagrams of FIG. 28B and FIG. 28C showing field curvature aberrations, the changes in focal lengths of the representative wavelengths within the entire field of view fall within +1.25 mm. The distortion aberration diagram of FIG. 28D shows that the distortion aberrations of this embodiment are maintained within a range of ±26%.

From the above description, it can be known that the aperture of the ocular optical system of the sixth embodiment is slightly larger than that of the first embodiment. It may also be said that the sixth embodiment has better sensitivity. In addition, the sixth embodiment has more preferable distortion than the first embodiment, and has improved imaging quality.

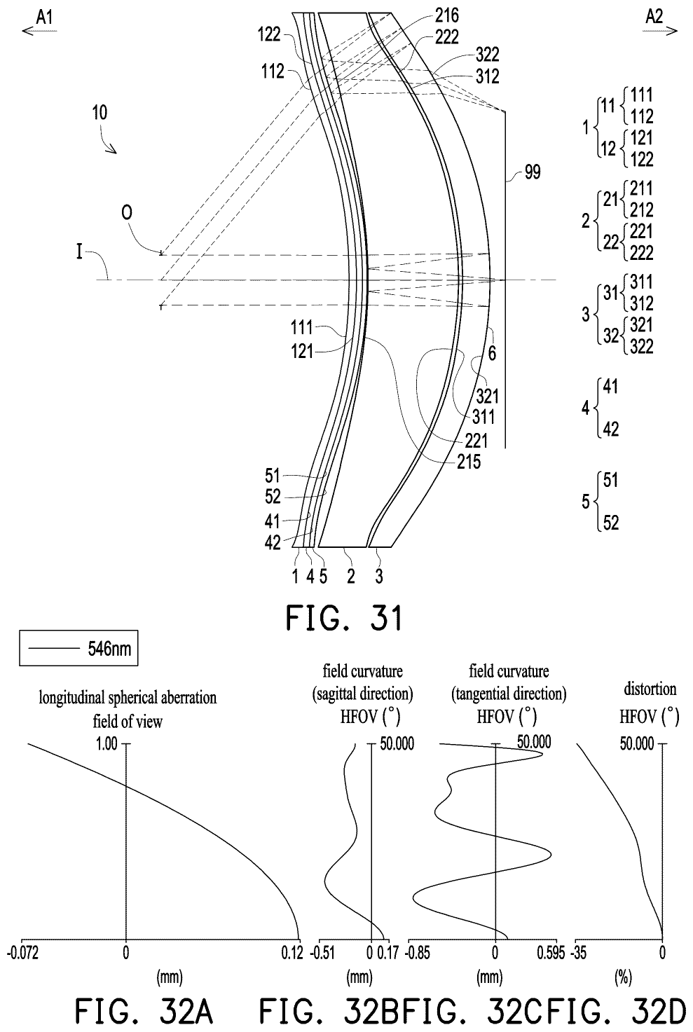

FIG. 31 is a schematic diagram of an ocular optical system according to the seventh embodiment of the present disclosure. FIG. 32A to FIG. 32D are diagrams of longitudinal spherical aberrations and various optical aberrations of the ocular optical system of the seventh embodiment of the disclosure. Please refer to FIG. 31 first. The seventh embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5.

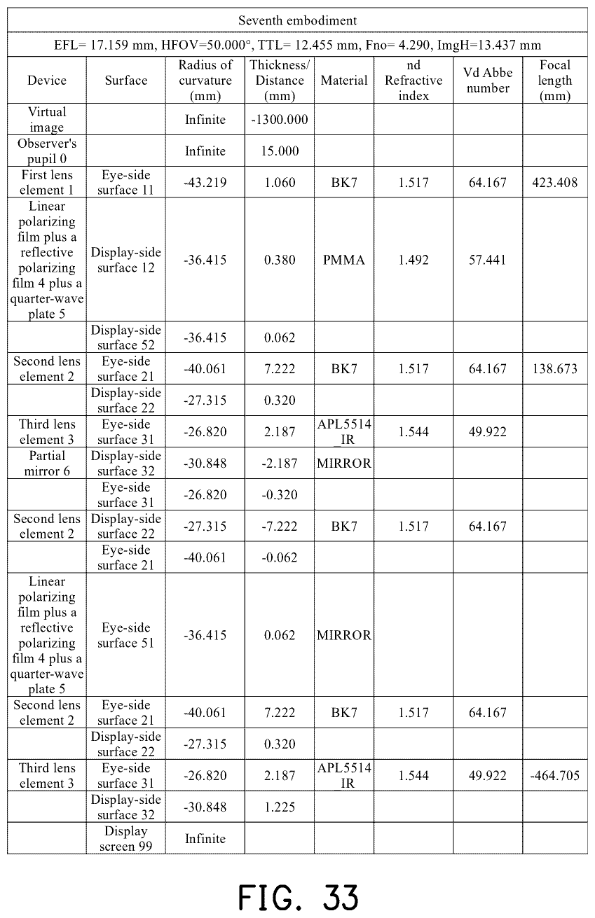

The detailed optical data of the ocular optical system 10 of the seventh embodiment is shown in FIG. 33, and the EFL of the ocular optical system 10 of the seventh embodiment is 17.159 mm, the HFOV is 50.000 degrees, the TTL is 12.455 mm, the Fno is 4.290, and the ImgH is 13.437 mm.

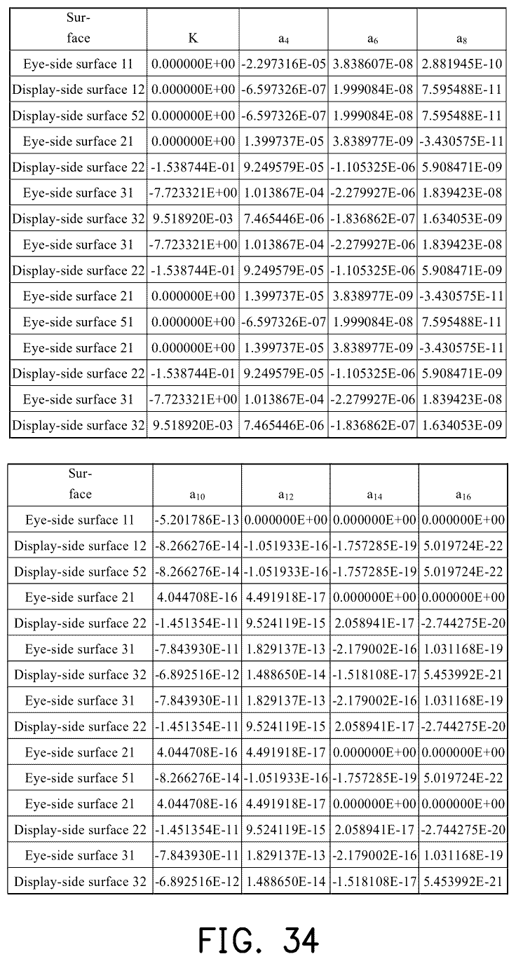

FIG. 34 also shows aspheric coefficients of the eye-side surfaces 11, 21, 31, 41 and 51 and the display-side surfaces 12, 22, 32, 42 and 52 of the seventh embodiment in the above formula (1).

In addition, the relationship between the important parameters in the ocular optical system 10 of the seventh embodiment is shown in FIG. 59 to FIG. 61.

FIG. 32A shows the longitudinal spherical aberrations of the seventh embodiment. The deviations of imaging points of the off-axis rays at different heights are controlled within a range of ±0.12 mm. In the two diagrams of FIG. 32B and FIG. 32C showing field curvature aberrations, the changes in focal lengths of the representative wavelengths within the entire field of view fall within +0.85 mm. The distortion aberration diagram of FIG. 32D shows that the distortion aberrations of this embodiment are maintained within a range of ±35%.

From the above description, it can be known that the length TTL of the ocular optical system 10 of the seventh embodiment is shorter than that of the first embodiment, so the seventh embodiment may have a smaller size. The seventh embodiment also has a higher image height. In addition, the seventh embodiment has more preferable field curvature, distortion and longitudinal spherical aberrations than the first embodiment, and has improved imaging quality.

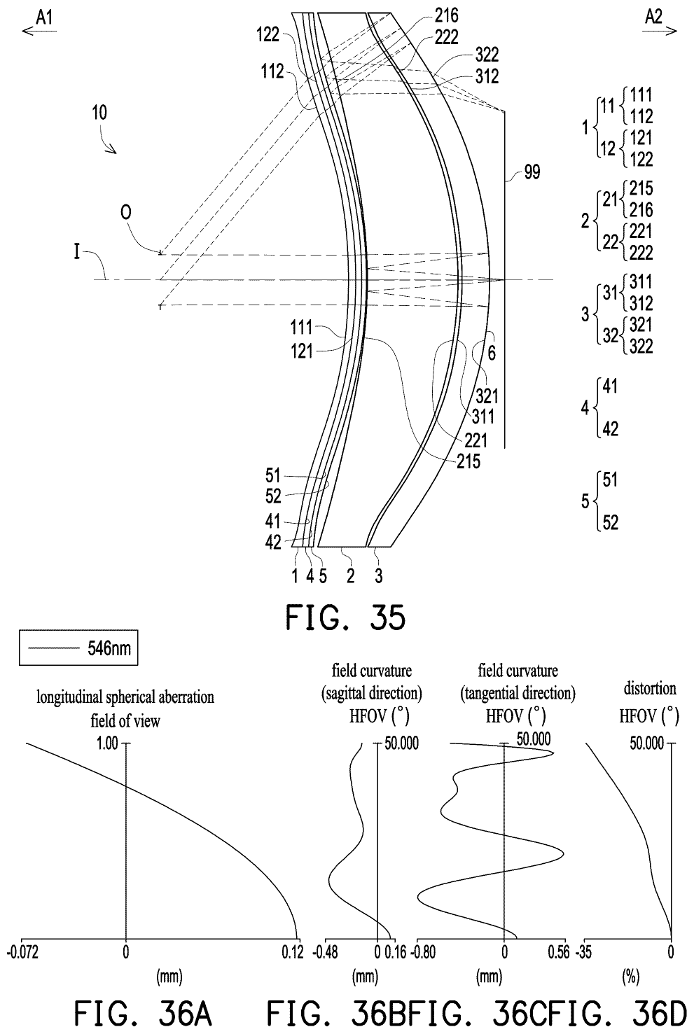

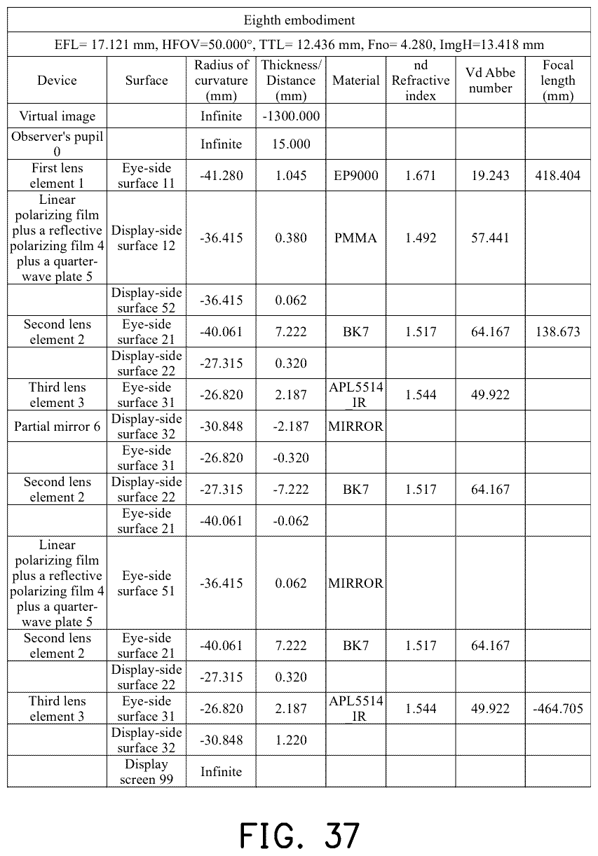

FIG. 35 is a schematic diagram of an ocular optical system according to the eighth embodiment of the present disclosure. FIG. 36A to FIG. 36D are diagrams of longitudinal spherical aberrations and various optical aberrations of the ocular optical system of the eighth embodiment of the disclosure. Please refer to FIG. 35 first. The eighth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5.

The detailed optical data of the ocular optical system 10 of the eighth embodiment is shown in FIG. 37, and the EFL of the ocular optical system 10 of the eighth embodiment is 17.121 mm, the HFOV is 50.000 degrees, the TTL is 12.436 mm, the Fno is 4.280, and the ImgH is 13.418 mm.

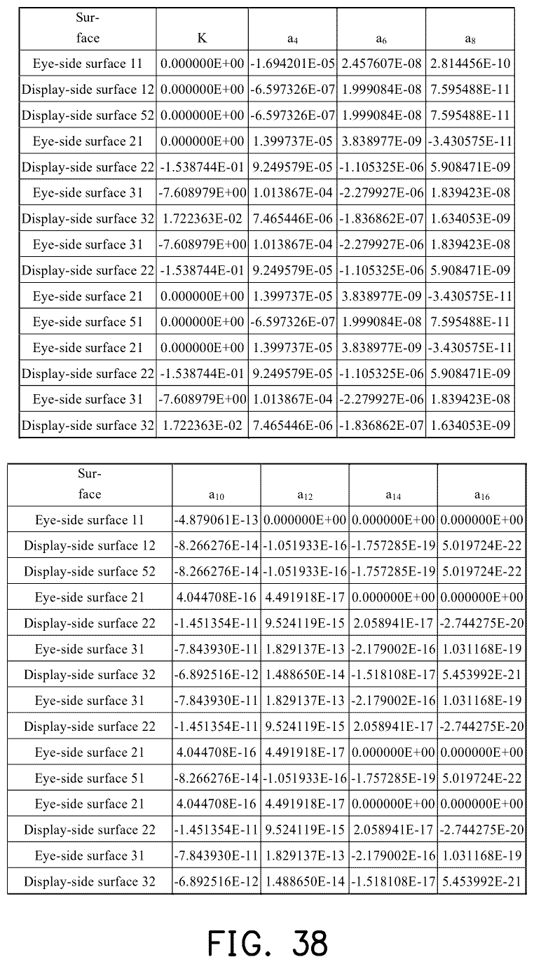

FIG. 38 also shows aspheric coefficients of the eye-side surfaces 11, 21, 31, 41 and 51 and the display-side surfaces 12, 22, 32, 42 and 52 of the eighth embodiment in the above formula (1).

In addition, the relationship between the important parameters in the ocular optical system 10 of the eighth embodiment is shown in FIG. 62 to FIG. 64.

FIG. 36A shows the longitudinal spherical aberrations of the eighth embodiment. The deviations of imaging points of the off-axis rays at different heights are controlled within a range of +0.12 mm. In the two diagrams of FIG. 36B and FIG. 36C showing field curvature aberrations, the changes in focal lengths of the representative wavelengths within the entire field of view fall within +0.8 mm. The distortion aberration diagram of FIG. 36D shows that the distortion aberrations of this embodiment are maintained within a range of ±35%.

From the above description, it can be known that the length TTL of the ocular optical system 10 of the eighth embodiment is shorter than that of the first embodiment, so the eighth embodiment may have a smaller size. The eighth embodiment also has a larger aperture and a higher image height. In addition, the eighth embodiment has more preferable field curvature, distortion and longitudinal spherical aberrations than the first embodiment, and has improved imaging quality.

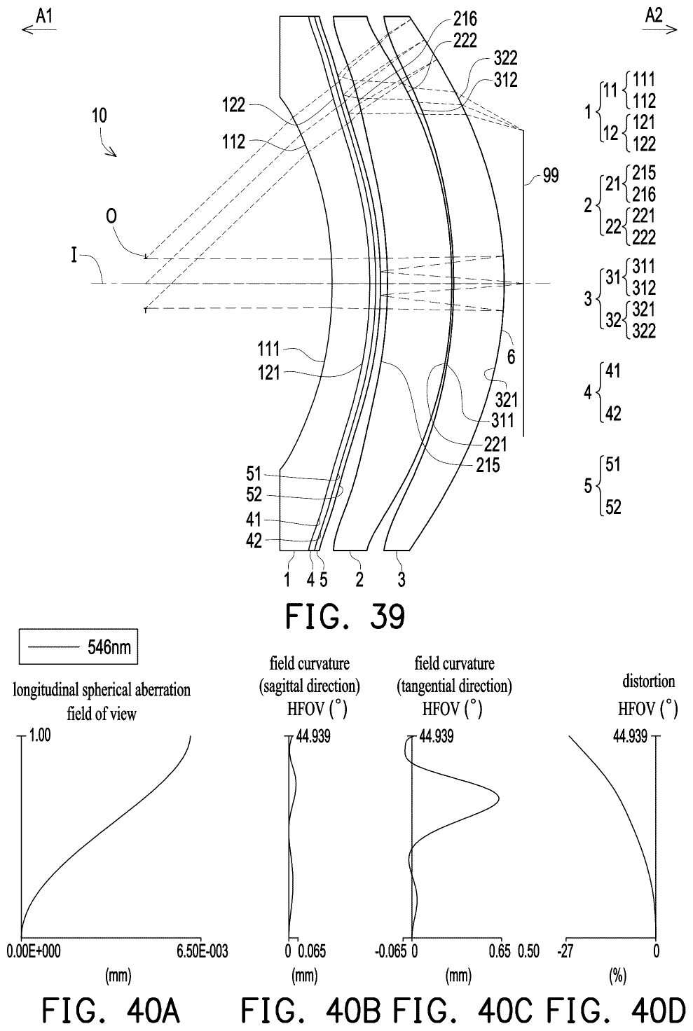

FIG. 39 is a schematic diagram of an ocular optical system according to the ninth embodiment of the present disclosure. FIG. 40A to FIG. 40D are diagrams of longitudinal spherical aberrations and various optical aberrations of the ocular optical system of the ninth embodiment of the disclosure. Please refer to FIG. 39 first. The ninth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5. In addition, the second lens element 2 of the ninth embodiment has negative refracting power, and the third lens element 3 has positive refracting power. On the other hand, in this embodiment, in the radial direction of the second lens element 2, there is an inflection point from the optical axis I to the optical maximum radius of the display-side surface 22 of the second lens element 2.

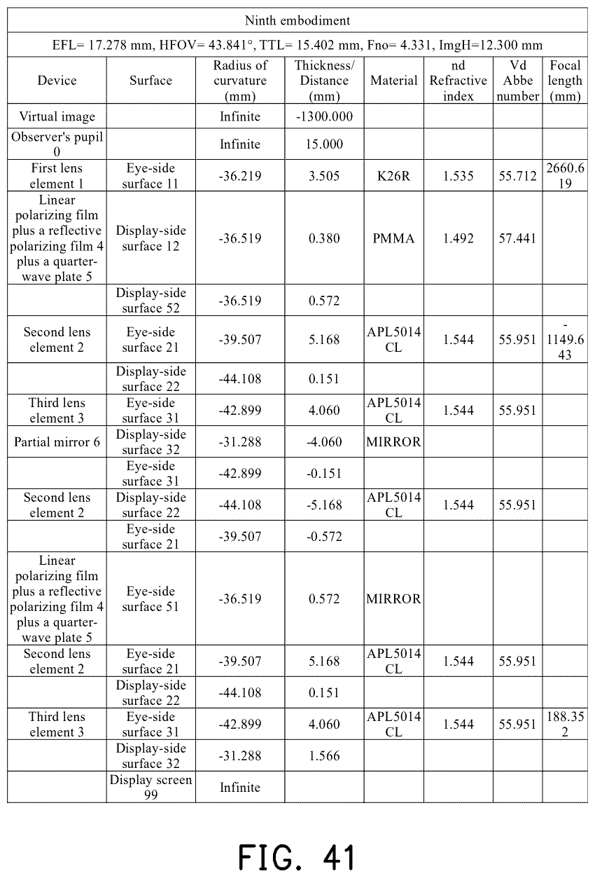

The detailed optical data of the ocular optical system 10 of the ninth embodiment is shown in FIG. 41, and the EFL of the ocular optical system 10 of the ninth embodiment is 17.278 mm, the HFOV is 43.841 degrees, the TTL is 15.402 mm, the Fno is 4.331, and the ImgH is 12.300 mm.

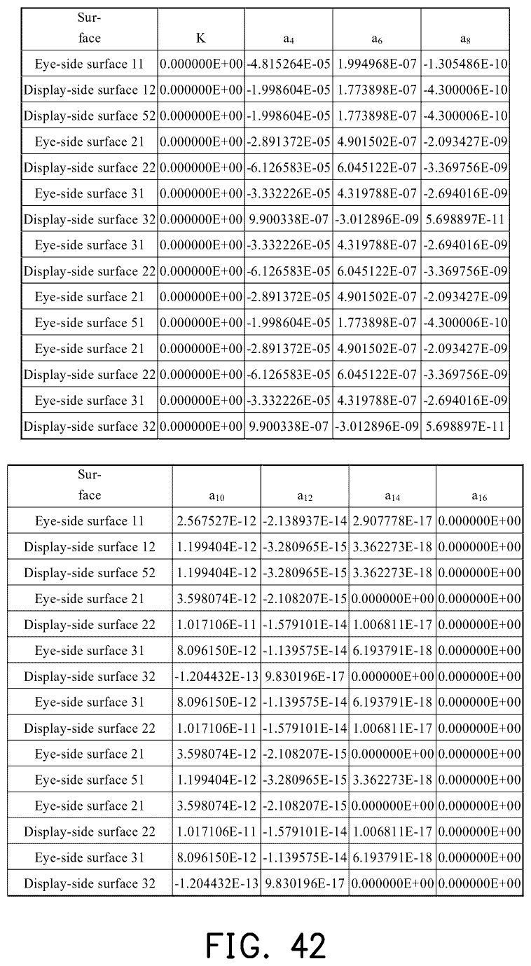

FIG. 42 also shows aspheric coefficients of the eye-side surfaces 11, 21, 31, 41 and 51 and the display-side surfaces 12, 22, 32, 42 and 52 of the ninth embodiment in the above formula (1).

In addition, the relationship between the important parameters in the ocular optical system 10 of the ninth embodiment is shown in FIG. 62 to FIG. 64.

FIG. 40A shows the longitudinal spherical aberrations of the ninth embodiment. The deviations of imaging points of the off-axis rays at different heights are controlled within a range of ±0.0065 mm. In the two diagrams of FIG. 40B and FIG. 40C showing field curvature aberrations, the changes in focal lengths of the representative wavelengths within the entire field of view fall within +0.65 mm. The distortion aberration diagram of FIG. 40D shows that the distortion aberrations of this embodiment are maintained within a range of ±27%.

From the above description, it can be known that the ocular optical system 10 of the ninth embodiment has a larger aperture, which means that the ninth embodiment has better sensitivity. In addition, the ninth embodiment has more preferable field curvature, distortion and longitudinal spherical aberrations than the first embodiment, and has improved imaging quality.

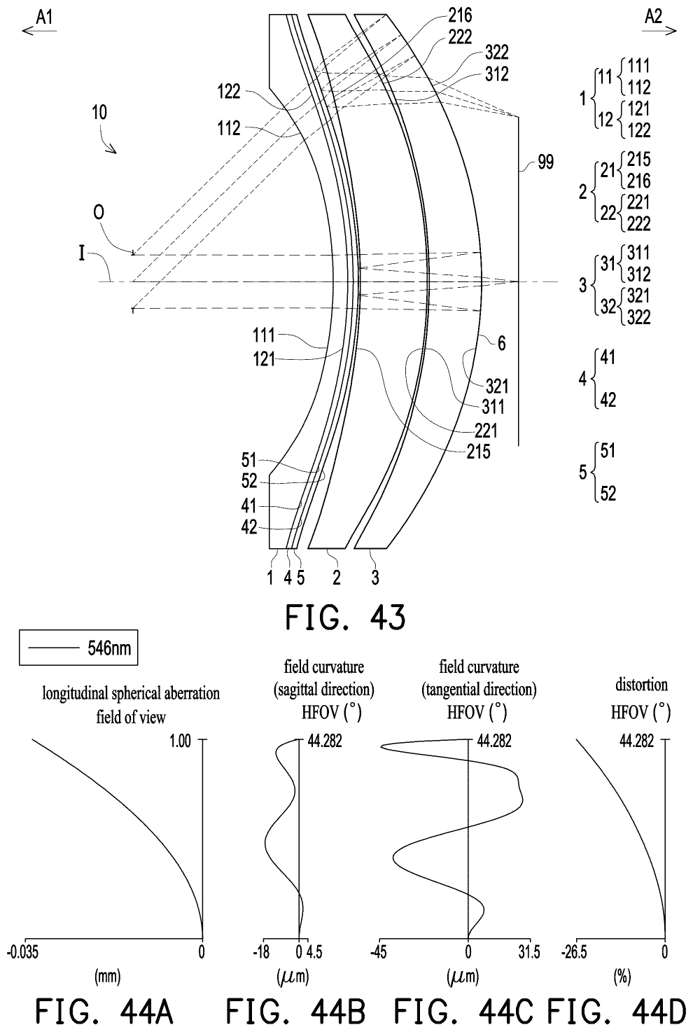

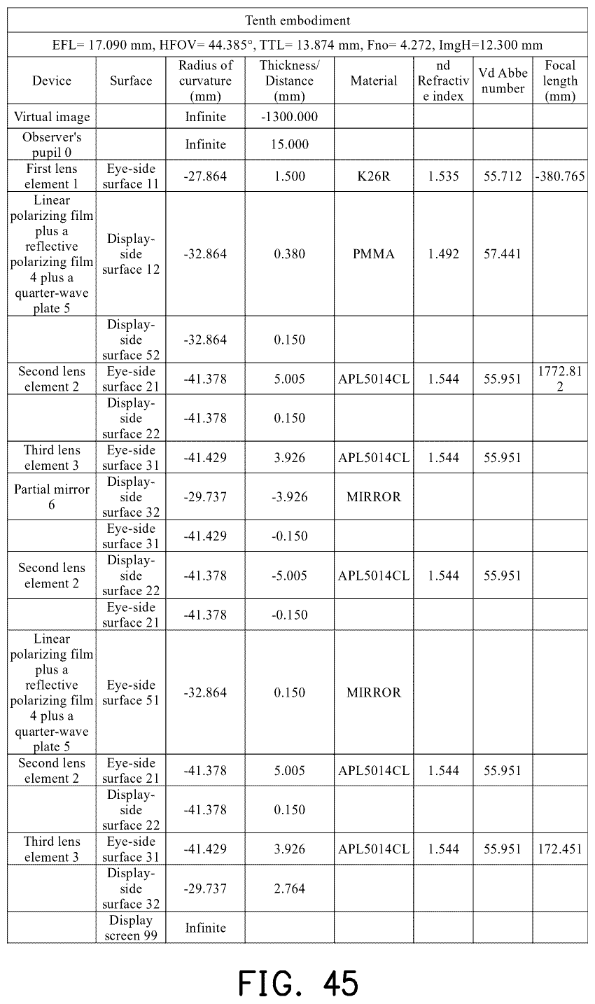

FIG. 43 is a schematic diagram of an ocular optical system according to the tenth embodiment of the present disclosure. FIG. 44A to FIG. 44D are diagrams of longitudinal spherical aberrations and various optical aberrations of the ocular optical system of the tenth embodiment of the disclosure. Please refer to FIG. 43 first. The tenth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5. In addition, the first lens element 1 of the tenth embodiment has negative refracting power, and the third lens element 3 has positive refracting power. On the other hand, in this embodiment, in the radial direction of the second lens element 2, there is an inflection point from the optical axis I to the optical maximum radius of the display-side surface 22 of the second lens element 2.

The detailed optical data of the ocular optical system 10 of the tenth embodiment is shown in FIG. 45, and the EFL of the ocular optical system 10 of the tenth embodiment is 17.090 mm, the HFOV is 44.385 degrees, the TTL is 13.874 mm, the Fno is 4.272, and the ImgH is 12.300 mm.

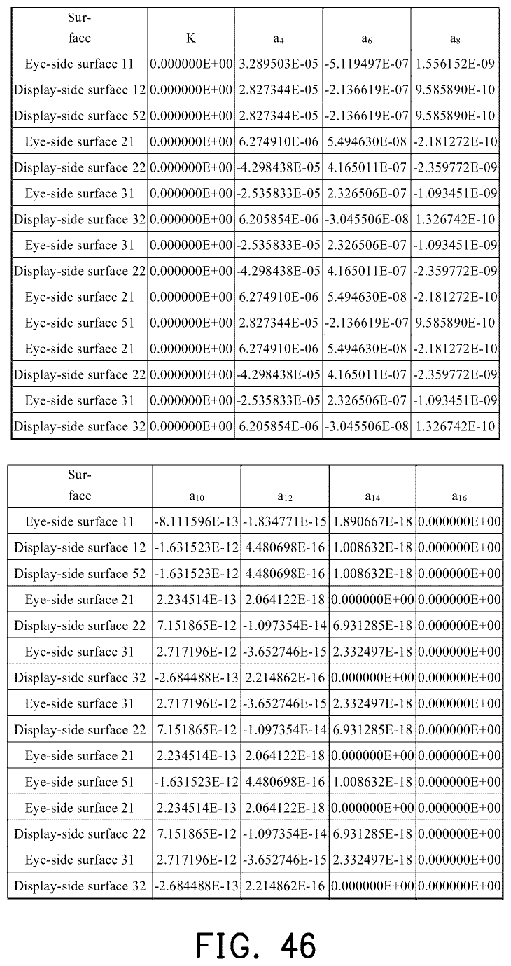

FIG. 46 also shows aspheric coefficients of the eye-side surfaces 11, 21, 31, 41 and 51 and the display-side surfaces 12, 22, 32, 42 and 52 of the tenth embodiment in the above formula (1).

In addition, the relationship between the important parameters in the ocular optical system 10 of the tenth embodiment is shown in FIG. 62 to FIG. 64.

FIG. 44A shows the longitudinal spherical aberrations of the tenth embodiment. The deviations of imaging points of the off-axis rays at different heights are controlled within a range of ±0.035 mm. In the two diagrams of FIG. 44B and FIG. 44C showing field curvature aberrations, the changes in focal lengths of the representative wavelengths within the entire field of view fall within +45 μm. The distortion aberration diagram of FIG. 44D shows that the distortion aberrations of this embodiment are maintained within a range of ±26.5%.

From the above description, it can be known that the ocular optical system 10 of the tenth embodiment has a larger aperture, which means that the tenth embodiment has better sensitivity. In addition, the field curvature, distortion and longitudinal spherical aberrations of the tenth embodiment are better controlled than the first embodiment, and therefore the tenth embodiment has improved imaging quality.

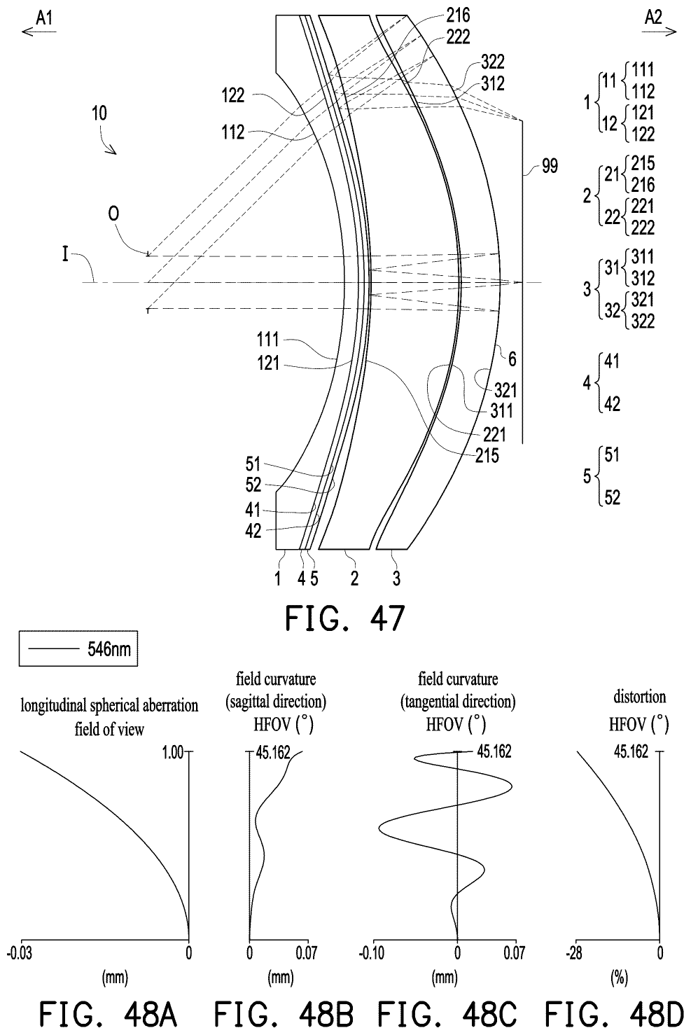

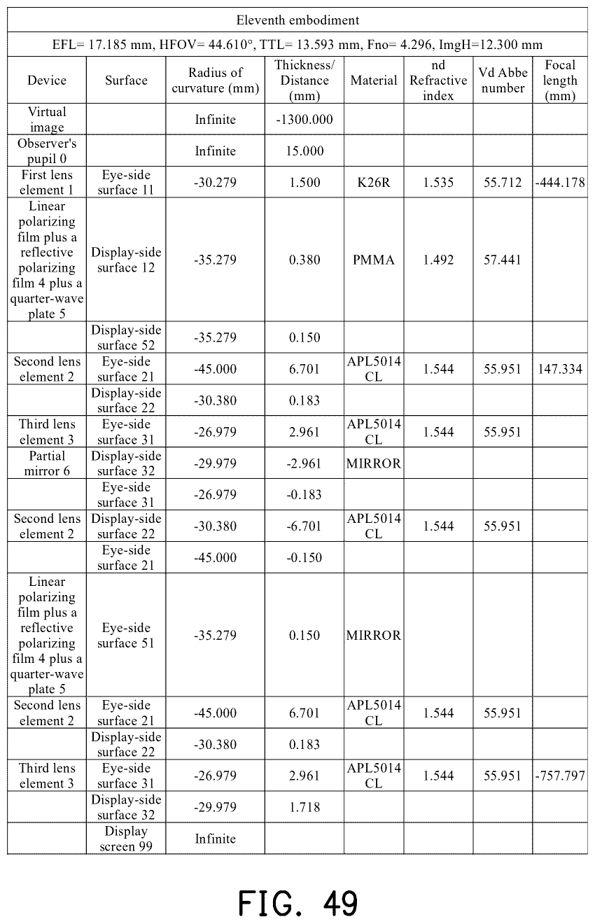

FIG. 47 is a schematic diagram of an ocular optical system according to the eleventh embodiment of the present disclosure. FIG. 48A to FIG. 48D are diagrams of longitudinal spherical aberrations and various optical aberrations of the ocular optical system of the eleventh embodiment of the disclosure. Please refer to FIG. 47 first. The eleventh embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5. In addition, the first lens element 1 of the eleventh embodiment has negative refracting power. On the other hand, in this embodiment, in the radial direction of the second lens element 2, there is an inflection point from the optical axis I to the optical maximum radius of the display-side surface 22 of the second lens element 2.

The detailed optical data of the ocular optical system 10 of the eleventh embodiment is shown in FIG. 49, and the EFL of the ocular optical system 10 of the eleventh embodiment is 17.185 mm, the HFOV is 44.610 degrees, the TTL is 13.593 mm, the Fno is 4.296, and the ImgH is 12.300 mm.

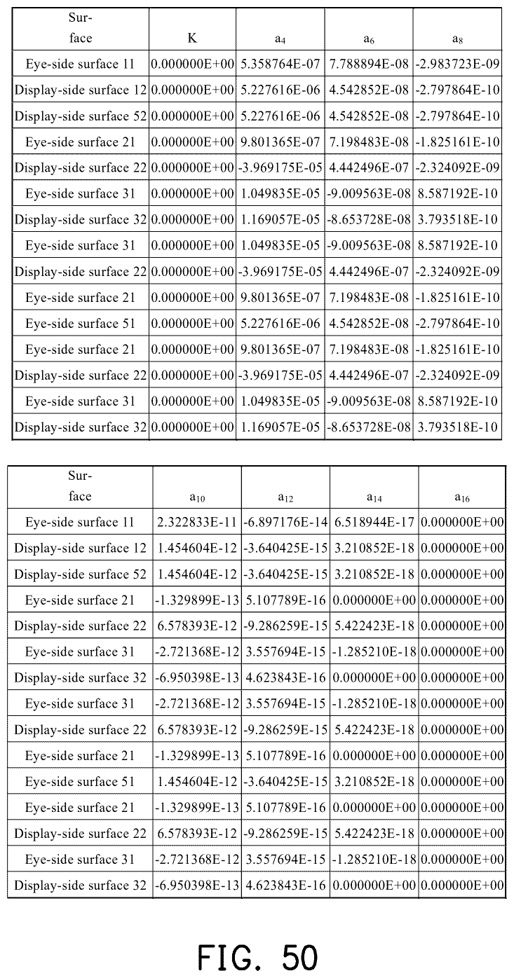

FIG. 50 also shows aspheric coefficients of the eye-side surfaces 11, 21, 31, 41 and 51 and the display-side surfaces 12, 22, 32, 42 and 52 of the eleventh embodiment in the above formula (1).

In addition, the relationship between the important parameters in the ocular optical system 10 of the eleventh embodiment is shown in FIG. 62 to FIG. 64.

FIG. 48A shows the longitudinal spherical aberrations of the eleventh embodiment. The deviations of imaging points of the off-axis rays at different heights are controlled within a range of ±0.03 mm. In the two diagrams of FIG. 48B and FIG. 48C showing field curvature aberrations, the changes in focal lengths of the representative wavelengths within the entire field of view fall within +0.1 mm. The distortion aberration diagram of FIG. 48D shows that the distortion aberrations of this embodiment are maintained within a range of ±28%.

From the above description, it can be known that the field curvature, distortion and longitudinal spherical aberrations of the ocular optical system 10 of the eleventh embodiment are better controlled than the first embodiment, and therefore the eleventh embodiment has improved imaging quality.

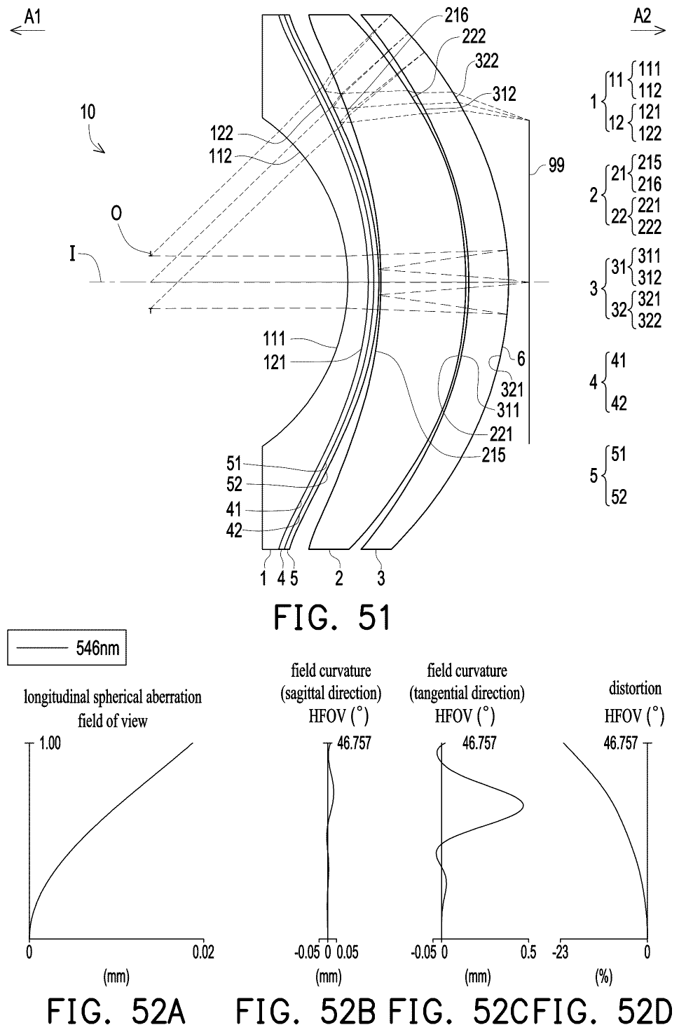

FIG. 51 is a schematic diagram of an ocular optical system according to the twelfth embodiment of the present disclosure. FIG. 52A to FIG. 52D are diagrams of longitudinal spherical aberrations and various optical aberrations of the ocular optical system of the twelfth embodiment of the disclosure. Please refer to FIG. 51 first. The twelfth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5. In addition, the first lens element 1 of the twelfth embodiment has negative refracting power, and the third lens element 3 has positive refracting power. On the other hand, in this embodiment, in the radial direction of the second lens element 2, there is an inflection point from the optical axis I to the optical maximum radius of the display-side surface 22 of the second lens element 2.

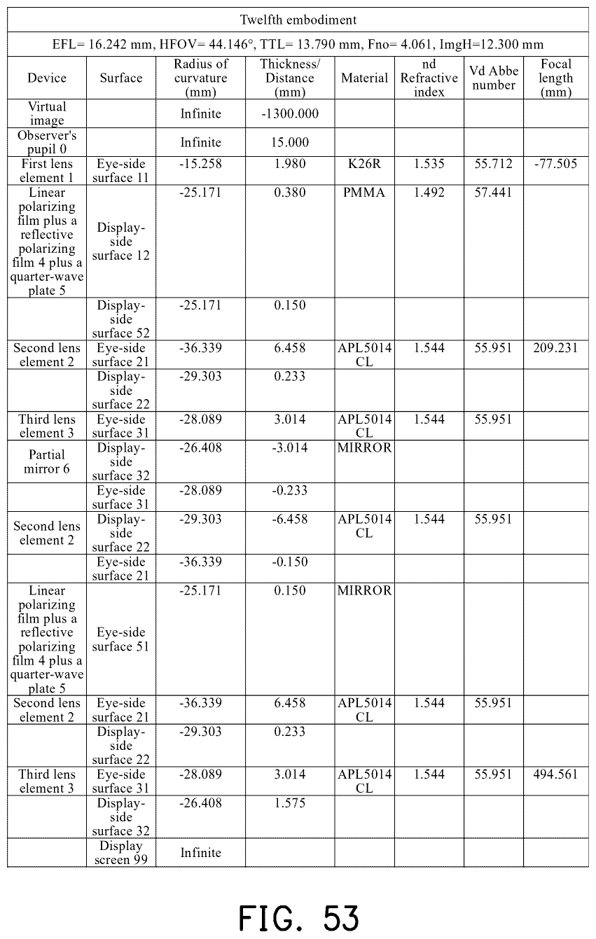

The detailed optical data of the ocular optical system 10 of the twelfth embodiment is shown in FIG. 53, and the EFL of the ocular optical system 10 of the twelfth embodiment is 16.242 mm, the HFOV is 44.146 degrees, the TTL is 13.790 mm, the Fno is 4.061, and the ImgH is 12.300 mm.

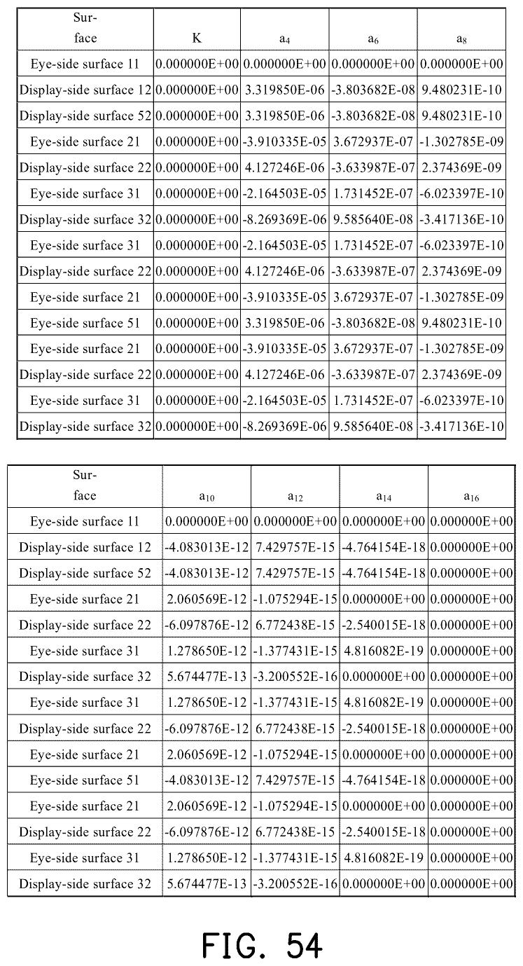

FIG. 54 also shows aspheric coefficients of the eye-side surfaces 11, 21, 31, 41 and 51 and the display-side surfaces 12, 22, 32, 42 and 52 of the twelfth embodiment in the above formula (1).

In addition, the relationship between the important parameters in the ocular optical system 10 of the twelfth embodiment is shown in FIG. 62 to FIG. 64.

FIG. 52A shows the longitudinal spherical aberrations of the twelfth embodiment. The deviations of imaging points of the off-axis rays at different heights are controlled within a range of ±0.02 mm. In the two diagrams of FIG. 52B and FIG. 52C showing field curvature aberrations, the changes in focal lengths of the representative wavelengths within the entire field of view fall within ±0.5 mm. The distortion aberration diagram of FIG. 52D shows that the distortion aberrations of this embodiment are maintained within a range of ±23%.

From the above description, it can be known that the ocular optical system 10 of the twelfth embodiment has a larger aperture, indicating that the twelfth embodiment has better sensitivity. In addition, the field curvature, distortion and longitudinal spherical aberrations of the twelfth embodiment are better controlled than the first embodiment, and therefore the twelfth embodiment has improved imaging quality.

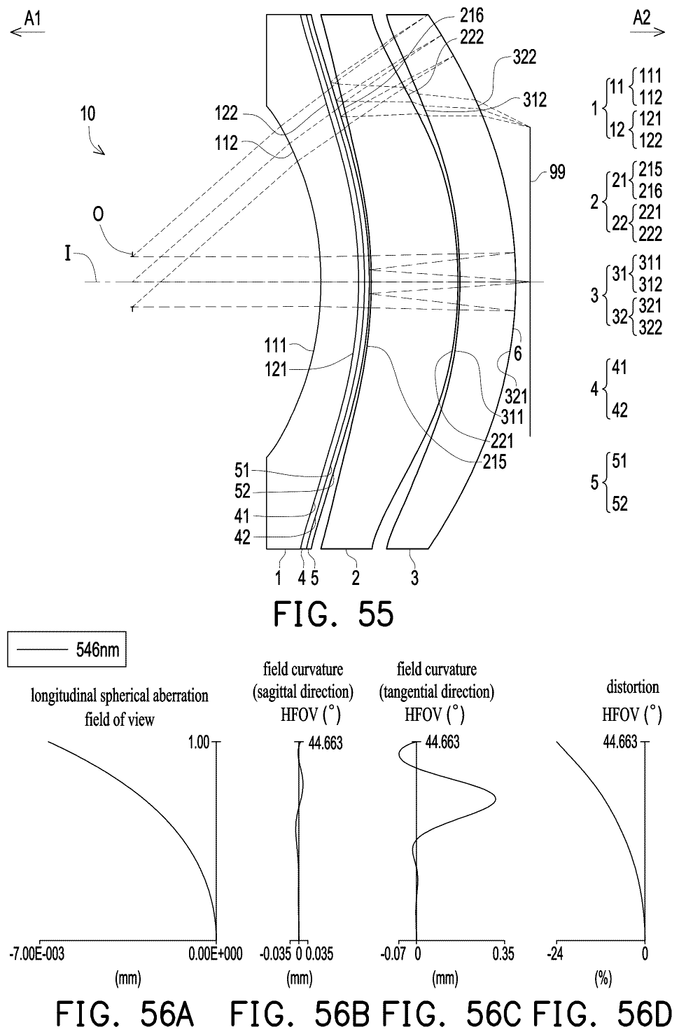

FIG. 55 is a schematic diagram of an ocular optical system according to the thirteenth embodiment of the present disclosure. FIG. 56A to FIG. 56D are diagrams of longitudinal spherical aberrations and various optical aberrations of the ocular optical system of the thirteenth embodiment of the disclosure. Please refer to FIG. 55 first. The thirteenth embodiment of the ocular optical system 10 of the present disclosure is substantially similar to the first embodiment, and the differences between the two are as follows: there are more or less some differences between the optical data, aspheric coefficients and the parameters of the first lens element 1, the second lens element 2, the third lens element 3, the linear polarizing film and the reflective polarizing film 4 and the quarter-wave plate 5. In addition, the first lens element 1 of the thirteenth embodiment has negative refracting power, and the third lens element 3 has positive refracting power. On the other hand, in this embodiment, in the radial direction of the second lens element 2, there is an inflection point from the optical axis I to the optical maximum radius of the display-side surface 22 of the second lens element 2.

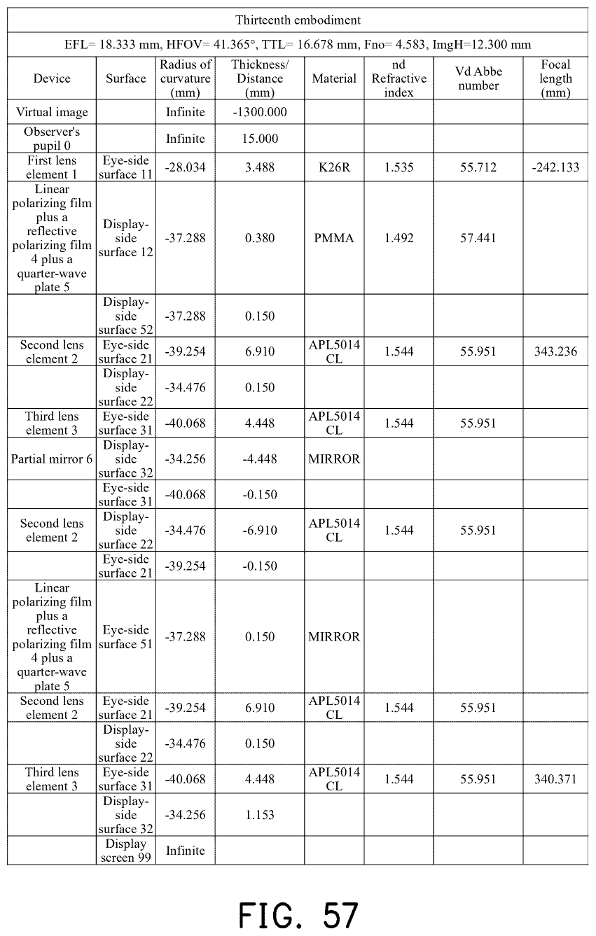

The detailed optical data of the ocular optical system 10 of the thirteenth embodiment is shown in FIG. 57, and the EFL of the ocular optical system 10 of the thirteenth embodiment is 18.333 mm, the HFOV is 41.365 degrees, the TTL is 16.678 mm, the Fno is 4.583, and the ImgH is 12.300 mm.

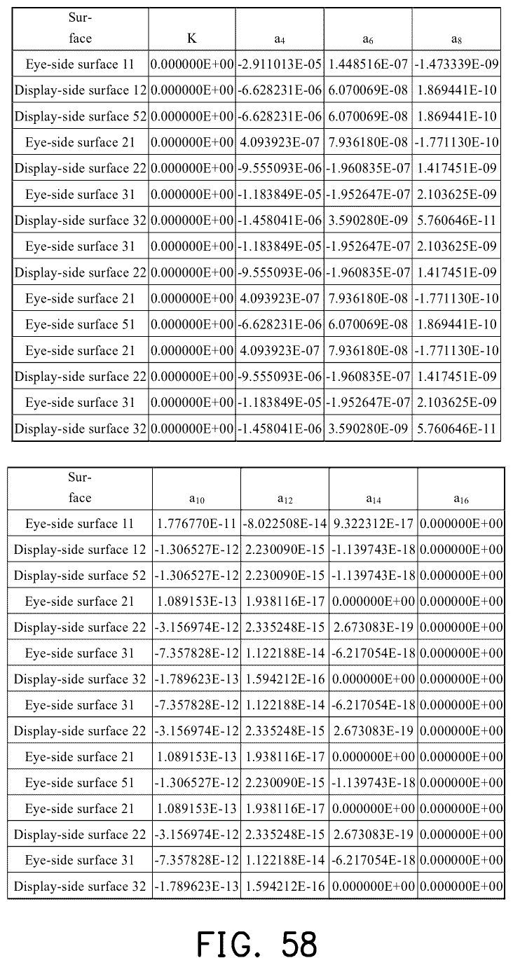

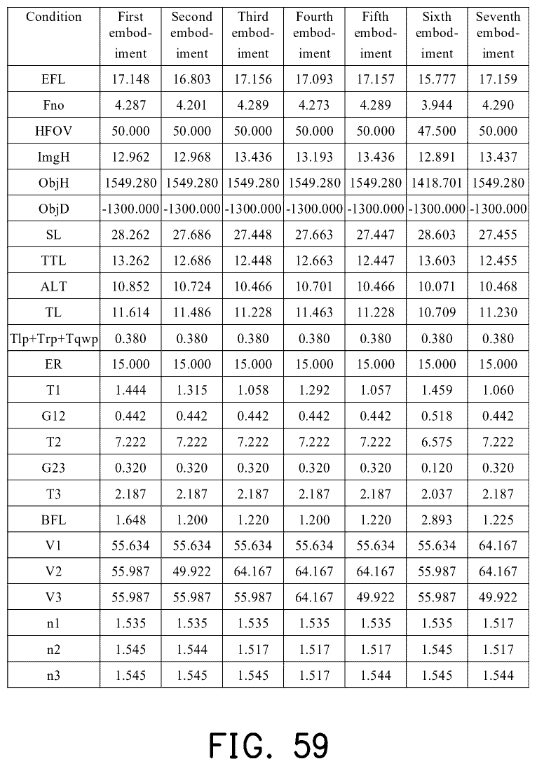

FIG. 58 also shows aspheric coefficients of the eye-side surfaces 11, 21, 31, 41 and 51 and the display-side surfaces 12, 22, 32, 42 and 52 of the thirteenth embodiment in the above formula (1).

In addition, the relationship between the important parameters in the ocular optical system 10 of the thirteenth embodiment is shown in FIG. 62 to FIG. 64.

FIG. 56A shows the longitudinal spherical aberrations of the thirteenth embodiment. The deviations of imaging points of the off-axis rays at different heights are controlled within a range of ±0.007 mm. In the two diagrams of FIG. 56B and FIG. 56C showing field curvature aberrations, the changes in focal lengths of the representative wavelengths within the entire field of view fall within +0.35 mm. The distortion aberration diagram of FIG. 56D shows that the distortion aberrations of this embodiment are maintained within a range of ±24%.

From the above description, it can be known that the field curvature, distortion and longitudinal spherical aberrations of the ocular optical system 10 of the thirteenth embodiment are better controlled than the first embodiment, and therefore the thirteenth embodiment has improved imaging quality.

In an embodiment of the present disclosure, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. The optical axis regions 111, 215, and 311 are all concave, plus the curvature directions of the optical axis regions 121, 221, and 321 are all the same (for example, they are all convex), together with the settings of the linear polarizing film and the reflective polarizing film 4, the quarter-wave plate 5, and the partial mirror 6, it is possible to improve the resolution of the modulation transfer function (MTF). In addition, by further limiting the following conditional expression: 1.9≤|OXR11/Sag11|≤8.5; or 2.9≤|OXR12/Sag12|≤9.0; or |Sag12|≤7.0 mm, it is possible to improve the slope of the optical maximum radius and Sag value, so as to reduce the degree of change in the Sag value of the surface shape of the first lens element 1. In this way, when the linear polarizing film and the reflective polarizing film 4 and the quarter-wave plate 5 are disposed on the display-side surface 12 of the first lens element 1 using 3D film coating technology, the process yield may be improved. The preferable limitation to the conditional expression is: 2.2 mm≤|Sag12|≤5.0 mm, which may further improve the yield of 3D film and prevent the Sag value from changing too little to correct the field curvature aberrations or cause the resolution to decrease. In addition, the conditional expression may be further limited as: 4.0 mm≤|Sag12|≤7.0 mm to help reduce longitudinal spherical aberrations, field curvature aberrations and distortion to improve imaging quality.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. By further limiting T2>T3 or T1>T3, and reducing the length of the ocular optical system 10 in conjunction with the above-mentioned optical principles of reflection and polarization, it is possible to achieve lightweight of the device.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditions: OXR11 is consistent with OXR32; or OXR12 is consistent with OXR32; or OXR21 is consistent with OXR32; or OXR22 is consistent with OXR32; or OXR31 is consistent with OXR32. In conjunction with the above conditions, it is possible to make the optical maximum radius and the size of the mounting portion of the first lens element 1, the second lens element 2 and the third lens element 3 to be consistent with each other, improve the assembly yield of each lens element, and reduce the probability of eccentricity of the ocular optical system 10. The term “consistent” may be interpreted as consistency within the tolerance range of lens element manufacturing, and more specifically refers to the radius being consistent within the deviation range of ±5%.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditions: 10≤V1/n1≤45; or 32≤V2/n2≤45; or 32≤V3/n3≤45. In conjunction with the above conditions, it is possible for the second lens element 2 and the third lens element 3 to adopt plastic or glass materials with low birefringence, such as APEL, PMMA or BK7, etc., which helps to reduce the stress of each lens element, thereby preventing ghosts from occurring when ray passes through each optical element. The more preferable limitation is: 32≤V1/n1≤45.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditions: 9.5≤(ER+TL+BFL)/BFL≤28.0; or 1.55≤(ER+TL+BFL)/EFL≤1.9; or 3.5≤TL/BFL≤13.5. In conjunction with the above conditions, it is possible to help maintain the length of the ocular optical system 10 while reducing the back focal length (i.e., BFL). The more preferable limitation is 9.5≤(ER+TL+BFL)/BFL≤24.0 or 3.5≤TL/BFL≤9.6, which helps to shorten the length of the ocular optical system 10 and increase the half field of view.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditions: 1.00≤OXR11/ImgH≤1.75; or 1.55≤OXR12/ImgH≤1.80; or 1.55≤OXR21/ImgH≤1.80; or 1.55≤OXR22/ImgH≤1.80; or 1.55≤OXR31/ImgH≤1.80; or 1.55≤OXR32/ImgH≤1.80. In conjunction with the above conditions, it is possible to help reduce the size and weight of the display (that is, the display that provides the display screen 99), thereby reducing the size and weight of the ocular optical system 10.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditions: 40≤|ObjD|/SL≤49; or 77≤|ObjD|/TTL≤110; or 82≤|ObjD|/TL≤125. In conjunction with the above conditions, it is possible to further increase the distance and height of the virtual image to help improve the magnification of the ocular optical system 10, so that the magnification satisfies 90≤ObjH/ImgH≤120 under the premise of taking into account the imaging quality and resolution.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditions: 3.0≤OXR11/T1≤21.0; or 5.0≤OXR12/T1≤21.0; or 2.5≤OXR21/T2≤4.3; or 2.5≤OXR22/T2≤4.3; or 4.7≤OXR31/T3≤10.5; or 4.7≤OXR32/T3≤10.5. In conjunction with the above conditions, it is possible to maintain the thickness and size of the first lens element 1, the second lens element 2 and the third lens element 3 within a suitable range to increase the manufacturing yield. The preferred limitation is 6.0≤OXR11/T1≤21.0; or 8.0≤OXR12/T1≤21.0; or 6.6≤OXR31/T3≤10.5; or 6.6≤OXR32/T3≤10.5. When satisfying the above conditional expression, it is possible to help shorten the length of the ocular optical system and increase the half field of view.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditional expression: 1.3≤T1/AAG≤5.2; or 4.6≤T2/AAG≤11.0; or 2.6≤T3/AAG≤6.6. In conjunction with the above conditions, it is possible to reduce the distance (i.e. G12) between the first lens element 1 and the second lens element 2, and reduce the distance (i.e. G23) between the second lens element 2 and the third lens element 3, so that most of the optical path of the rays emitted by the display screen 99 is on the optical material, thus increasing the refracted optical path to increase the field of view. The preferred limitation is 1.3≤T1/AAG≤3.4 or 2.6≤T3/AAG≤5.8, which helps to maintain the system length while increasing the field of view.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditional expression: 3.6≤ER/T1≤15.0; or 2.05≤ER/T2≤3.00; or 3.3≤ER/T3≤7.5. In conjunction with the above conditions, it is possible for the ocular optical system 10 to have a suitable eye distance range from 5 mm to 20 mm. The above conditions help to maintain an appropriate distance between the ocular optical system 10 and the pupil 0, so that the observer will be less likely to suffer from visual fatigue. The preferred limitation is 7.5≤ER/T1≤15.0 or 2.05≤ER/T2≤2.35 or 4.9≤ER/T3≤7.5, which helps to shorten the length of the ocular optical system 10.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditional expression: 2.0≤(OXR11+OXR12)/(ImgH+BFL)≤3.1; or 2.6≤(OXR21+OXR22)/(ImgH+BFL)≤3.5; or 2.6≤(OXR31+OXR32)/(ImgH+BFL)≤3.5. In conjunction with the above conditions, it is possible to increase the magnification of the virtual image formed by the display screen 99 on the premise of reducing the size and weight of the display.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditional expression: 2.7≤ImgH/T1≤13.0; or 1.6≤ImgH/T2≤2.5; or 2.7≤ImgH/T3≤6.5. In conjunction with the above conditions, it is possible to reduce the size of the display by controlling the sizes of T1, T2, and T3. The preferred limitation is 4.8≤ImgH/T1≤13.0, which helps to shorten the length of the ocular optical system 10.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Moreover, the ocular optical system 10 may satisfy the following conditional expression: 4.4≤ImgH/BFL≤11.5; or 0.5≤T1/BFL≤3.7; or 2.2≤T2/BFL≤6.2; or 0.7≤T3/BFL≤3.9, so it is possible to reduce the length of the back focal length to increase the magnification of the virtual image. The preferred limitation is 0.5≤T1/BFL≤1.5 or 0.7≤T3/BFL≤2.6, which helps to shorten the system length.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Furthermore, the second lens element 2 has positive refracting power, and the third lens element 3 has negative refracting power. In conjunction with the above conditions, other than reducing the degree of change in the Sag value of the surface shape of the first lens element 1, it is also possible to increase the half field of view.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Furthermore, the second lens element 2 has negative refracting power, and the third lens element 3 has positive refracting power. In conjunction with the above conditions, other than reducing the degree of change in the Sag value of the surface shape of the first lens element 1, it is also possible to reduce longitudinal spherical aberrations and distortion.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Furthermore, the first lens element 1 has negative refracting power, and the second lens element 2 has positive refracting power. In conjunction with the above conditions, other than reducing the degree of change in the Sag value of the surface shape of the first lens element 1, it is also possible to reduce longitudinal spherical aberrations and field curvature aberrations.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Furthermore, in the radial direction of the second lens element 2, there is an inflection point from the optical axis I to the optical maximum radius of the display-side surface 22 of the second lens element 2. Through the above settings, it is possible to reduce the degree of change in the Sag value of the surface shape of the first lens element 1 while maintaining the imaging quality of the display screen 99. The preferred limitation is that, in the radial direction of the second lens element 2, there are two inflection points from the optical axis I to the optical maximum radius of the display-side surface 22 of the second lens element 2. On the premise of increasing the half field of view, it is possible to reduce the degree of change in the Sag value of the surface shape of the first lens element 1.

In an embodiment, by disposing the linear polarizing film and the reflective polarizing film 4 and the quarter-wave plate 5 on the display-side surface 12 of the first lens element 1, it is possible to help reduce the coating process to reduce manufacturing costs. Together with the above configuration and disposing a partial mirror 6 on the convex surface of the display-side surface 32 of the third lens element 3, it is possible to help increase the half field of view through the principles of reflection and polarization. Furthermore, the ocular optical system 10 may satisfy the following conditional expression: 2.4≤ALT/EPD≤3.8; or 2.5≤TL/EPD≤3.9; or 2.9≤ImgH/EPD≤3.4. In conjunction with the above conditional expression, it is possible to help to reduce the size of the ocular optical system 10 and increase the range of the display screen 99 viewed by the observer.

To sum up, the advantageous effects of the ocular optical system according to the embodiments of the present disclosure are: by satisfying the conditions of optical design, and disposing the linear polarizing film, the reflective polarizing film and the quarter-wave plate on the convex surface of the display-side surface of the first lens element, it is possible to help reduce the coating process to reduce manufacturing costs, and make the ocular optical system lighter. In addition, disposing a partial mirror on the convex surface of the display-side surface of the third lens element also helps to increase the half field of view through the principles of reflection and polarization, thus satisfying consumers' demand for a wide field of view of images.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:
(1) The ranges of the optical parameters are, for example, α₂≤A≤α₁ or β₂≤β≤β₁, where α₁ is a maximum value of the optical parameter A among the plurality of embodiments, α₂ is a minimum value of the optical parameter A among the plurality of embodiments, β₁ is a maximum value of the optical parameter B among the plurality of embodiments, and β₂ is a minimum value of the optical parameter B among the plurality of embodiments.
(2) The comparative relation between the optical parameters is that A is greater than B or A is less than B, for example.
(3) The range of a conditional expression covered by a plurality of embodiments is in detail a combination relation or proportional relation obtained by a possible operation of a plurality of optical parameters in each same embodiment. The relation is defined as E, and E is, for example, A+B or A−B or A/B or A*B or (A*B)^{1/2}, and E satisfies a conditional expression E≤γ₁ or E≥γ₂ or γ₂≤E≤γ₁, where each of γ₁ and γ₂ is a value obtained by an operation of the optical parameter A and the optical parameter B in a same embodiment, γ₁ is a maximum value among the plurality of the embodiments, and γ₂ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An ocular optical system, configured to allow an imaging ray from a display screen to enter an eye of an observer through the ocular optical system to form an image, wherein a side facing the eye is an eye-side and a side facing the display screen is a display-side, the ocular optical system comprises a first lens element, a second lens element and a third lens element arranged in sequence along an optical axis from the eye-side to the display-side, the first lens element to the third lens element each comprise an eye-side surface facing the eye-side and allowing the imaging ray to pass through, and a display-side surface facing the display-side and allowing the imaging ray to pass through, the ocular optical system further comprises a linear polarizing film, a reflective polarizing film, a quarter-wave plate and a partial mirror; the quarter-wave plate is disposed on the reflective polarizing film, the reflective polarizing film is disposed on the linear polarizing film, the linear polarizing film is disposed on a convex surface of an optical axis region of the display-side surface of the first lens element;
the partial mirror is disposed on a convex surface of an optical axis region of the display-side surface of the third lens element;
an optical axis region of the eye-side surface of the first lens element, an optical axis region of the eye-side surface of the second lens element, and an optical axis region of the eye-side surface of the third lens element are all concave;
a curvature direction of an optical axis region of the display-side surface of the second lens element is consistent with a curvature direction of the optical axis region of the display-side surface of the first lens element and a curvature direction of the optical axis region of the display-side surface of the third lens element;
the ocular optical system satisfies a conditional expression as follows: 1.9≤|OXR11/Sag11|≤8.5, wherein OXR11 is an optical maximum radius of the eye-side surface of the first lens element, Sag11 is a Sag value of the eye-side surface of the first lens element at the optical maximum radius, wherein Sag is a depth of an aspheric surface derived from an aspheric surface formula.

2. The ocular optical system according to claim 1, wherein OXR12 and OXR32 of the ocular optical system are consistent with each other, OXR12 is an optical maximum radius of the display-side surface of the first lens element, and OXR32 is an optical maximum radius of the display-side surface of the third lens element.

3. The ocular optical system according to claim 1, wherein the ocular optical system further satisfies the following conditional expression:
9.5≤(ER+TL+BFL)/BFL≤28.0, wherein ER is a distance from the eye of the observer to the first lens element on the optical axis, TL is a distance from the eye-side surface of the first lens element to the display-side surface of the third lens element on the optical axis, and BFL is a distance from the display-side surface of the third lens element to the display screen on the optical axis.

4. The ocular optical system according to claim 1, wherein the ocular optical system further satisfies the following conditional expression:
1.55≤OXR12/ImgH≤1.80, wherein OXR12 is an optical maximum radius of the display-side surface of the first lens element, and ImgH is a maximum image height of the ocular optical system.

5. The ocular optical system according to claim 1, wherein the ocular optical system further satisfies the following conditional expression:
5.0≤OXR12/T1≤21.0, wherein OXR12 is an optical maximum radius of the display-side surface of the first lens element, and T1 is a thickness of the first lens element on the optical axis.

6. The ocular optical system according to claim 1, wherein the ocular optical system further satisfies the following conditional expression:
1.3≤T1/AAG≤5.2, wherein T1 is a thickness of the first lens element on the optical axis, and AAG is a distance from the display-side surface of the first lens element to the eye-side surface of the second lens element on the optical axis plus a distance from the display-side surface of the second lens element to the eye-side surface of the third lens element on the optical axis.

7. The ocular optical system according to claim 1, wherein the ocular optical system further satisfies the following conditional expression:
2.6≤(OXR31+OXR32)/(ImgH+BFL)≤3.5, wherein OXR31 is an optical maximum radius of the eye-side surface of the third lens element, OXR32 is an optical maximum radius of the display-side surface of the third lens element, ImgH is a maximum image height of the ocular optical system, and BFL is a distance from the display-side surface of the third lens element to the display screen on the optical axis.

8. An ocular optical system, configured to allow an imaging ray from a display screen to enter an eye of an observer through the ocular optical system to form an image, wherein a side facing the eye is an eye-side and a side facing the display screen is a display-side, the ocular optical system comprises a first lens element, a second lens element and a third lens element sequentially arranged along an optical axis from the eye-side to the display-side, the first lens element to the third lens element each comprise an eye-side surface facing the eye-side and allowing the imaging ray to pass through, and a display-side surface facing the display-side and allowing the imaging ray to pass through, the ocular optical system further comprises a linear polarizing film, a reflective polarizing film, a quarter-wave plate and a partial mirror;
the quarter-wave plate is disposed on the reflective polarizing film, and the reflective polarizing film is disposed on the linear polarizing film, the linear polarizing film is disposed on a convex surface of an optical axis region of the display-side surface of the first lens element;
the partial mirror is disposed on a convex surface of an optical axis region of the display-side surface of the third lens element;
an optical axis region of the eye-side surface of the first lens element, an optical axis region of the eye-side surface of the second lens element, and an optical axis region of the eye-side surface of the third lens element are all concave;
a curvature direction of an optical axis region of the display-side surface of the second lens element is consistent with a curvature direction of the optical axis region of the display-side surface of the first lens element and a curvature direction of the optical axis region of the display-side surface of the third lens element;
the ocular optical system satisfies a conditional expression as follows: 2.9≤|OXR12/Sag12|≤9.0, wherein OXR12 is an optical maximum radius of the display-side surface of the first lens element, and Sag12 is a Sag value of the display-side surface of the first lens element at the optical maximum radius, wherein Sag is a depth of an aspherical surface obtained through an aspherical surface formula.

9. The ocular optical system according to claim 8, wherein the ocular optical system further satisfies a conditional expression as follows: 32≤V2/n2≤45, wherein V2 and n2 are respectively a Vd Abbe number and an nd refractive index of the second lens element.

10. The ocular optical system according to claim 8, wherein the ocular optical system further satisfies a conditional expression as follows:
3.5≤TL/BFL≤13.5, wherein TL is a distance from the eye-side surface of the first lens element to the display-side surface of the third lens element on the optical axis, and BFL is a distance from the display-side surface of the third lens element to the display screen on the optical axis.

11. The ocular optical system according to claim 8, wherein the ocular optical system further satisfies a conditional expression as follows:
1.00≤OXR11/ImgH≤1.70, wherein OXR11 is an optical maximum radius of the eye-side surface of the first lens element, and ImgH is a maximum image height of the ocular optical system.

12. The ocular optical system according to claim 8, wherein the ocular optical system further satisfies a conditional expression as follows:
2.5≤OXR22/T2≤4.3, wherein OXR22 is an optical maximum radius of the display-side surface of the second lens element, and T2 is a thickness of the second lens element on the optical axis.

13. The ocular optical system according to claim 8, wherein the ocular optical system further satisfies a conditional expression as follows:
4.6≤T2/AAG≤11.0, wherein T2 is a thickness of the second lens element on the optical axis, and AAG is a distance from the display-side surface of the first lens element to the eye-side surface of the second lens element on the optical axis plus a distance from the display-side surface of the second lens element to the eye-side surface of the third lens element on the optical axis.

14. The ocular optical system according to claim 8, wherein the ocular optical system further satisfies a conditional expression as follows:
2.9≤ImgH/EPD≤3.4, wherein ImgH is a maximum image height of the ocular optical system, and EPD is an exit pupil diameter of the ocular optical system, corresponding to a diameter of the eye.

15. An ocular optical system, configured to allow an imaging ray from a display screen to enter an eye of an observer through the ocular optical system to form an image, wherein a side facing the eye is an eye-side and a side facing the display screen is a display-side, the ocular optical system comprises a first lens element, a second lens element and a third lens element sequentially arranged along an optical axis from the eye-side to the display-side, the first lens element to the third lens element each comprise an eye-side surface facing the eye-side and allowing the imaging ray to pass through, and a display-side surface facing the display-side and allowing the imaging ray to pass through, the ocular optical system further comprises a linear polarizing film, a reflective polarizing film, a quarter-wave plate and a partial mirror;
the quarter-wave plate is disposed on the reflective polarizing film, and the reflective polarizing film is disposed on the linear polarizing film, the linear polarizing film is disposed on a convex surface of an optical axis region of the display-side surface of the first lens element;
the partial mirror is disposed on a convex surface of an optical axis region of the display-side surface of the third lens element;
an optical axis region of the eye-side surface of the first lens element, an optical axis region of the eye-side surface of the second lens element, and an optical axis region of the eye-side surface of the third lens element are all concave;
a curvature direction of an optical axis region of the display-side surface of the second lens element is consistent with a curvature direction of the optical axis region of the display-side surface of the first lens element and a curvature direction of the optical axis region of the display-side surface of the third lens element;
the ocular optical system satisfies a conditional expression as follows: |Sag12|≤7.0 mm, wherein Sag12 is a Sag value of the display-side surface of the first lens element at the optical maximum radius, wherein Sag is a depth of an aspherical surface obtained through an aspherical surface formula.

16. The ocular optical system according to claim 15, wherein the ocular optical system further satisfies a conditional expression as follows: 32≤V3/n3≤45, wherein V3 and n3 are respectively a Vd Abbe number and an nd refractive index of the third lens element.

17. The ocular optical system according to claim 15, wherein the ocular optical system further satisfies a conditional expression as follows:
82≤|ObjD|/TL≤125, wherein ObjD is a distance from the eye of the observer to a virtual image generated by the ocular optical system on the optical axis, and TL is a distance from the eye-side surface of the first lens element to the display-side surface of the third lens element on the optical axis.

18. The ocular optical system according to claim 15, wherein the ocular optical system further satisfies a conditional expression as follows:
4.7≤OXR32/T3≤10.5, wherein OXR32 is an optical maximum radius of the display-side surface of the third lens element, and T3 is a thickness of the third lens element on the optical axis.

19. The ocular optical system according to claim 15, wherein the ocular optical system further satisfies a conditional expression as follows:
2.6≤T3/AAG≤6.6, wherein T3 is a thickness of the third lens element on the optical axis, and AAG is a distance from the display-side surface of the first lens element to the eye-side surface of the second lens element on the optical axis plus a distance from the display-side surface of the second lens element to the eye-side surface of the third lens element on the optical axis.

20. The ocular optical system according to claim 15, wherein in a radial direction of the second lens element, there is an inflection point between the optical axis and an optical maximum radius of the display-side surface of the second lens element.
